(19) United States
(12) Patent Application Publication
(10) Pub. No.: US 2026/0338663 A1
(43) Pub. Date: Oct. 29, 2026

(54) RAPID TRAPPING AND CHARACTERIZATION OF NANOSCALE PARTICLES IN SOLUTION

(71) Applicant: Vanderbilt University, Nashville, TN (US)

(72) Inventors: Justus C. Ndukaife, Nashville, TN (US); Ikjun Hong, Nashville, TN (US); Guodong Zhu, Nashville, TN (US)

(21) Appl. No.: 19/647,398

(22) Filed: Apr. 14, 2026

Related U.S. Application Data
(60) Provisional application No. 63/789,182, filed on Apr. 15, 2025.

(51) Int. Cl. G01N 15/1433; G01N 15/14; G01N 15/1404; G01N 15/1434

(52) U.S. Cl. CPC G01N 15/1433; G01N 15/1404; G01N 15/1434; G01N 2015/1493; G01N 2015/1497

(57) ABSTRACT

A system includes a nanotweezer including a first electrode and a second electrode, the nanotweezer configured to generate electrohydrodynamic flows between the first electrode and the second electrode to trap nanoscale particles, a first coherent light source configured to illuminate the trapped nanoscale particles, a second coherent light source configured to illuminate the trapped nanoscale particles, a first sensor configured to monitor a first interaction between the first coherent light source and the trapped nanoscale particles, a second sensor configured to monitor a second interaction between the second coherent light source and the trapped nanoscale particles, and an electronic processor configured to determine particle sizes of the trapped nanoscale particles based on sensor signals from the first sensor and determine compositions of the trapped nanoscale particles based on sensor signals from the second sensor.

### CROSS-REFERENCE TO RELATED APPLICATIONS

This application claims the benefit of U.S. Provisional Application No. 63/789,182 filed Apr. 15, 2025, the entire disclosure of which is incorporated by reference.

### STATEMENT REGARDING FEDERALLY SPONSORED RESEARCH

This invention was made with government support under GM150572 awarded by the National Institutes of Health. The government has certain rights in the invention.

### FIELD

The present disclosure relates to nanotweezers for manipulating nanoscale objects and, more particularly, to interferometric electrohydrodynamic tweezers that facilitate particle size and shape characterization via interferometric imaging and molecular composition identification via Raman spectroscopy.

### SUMMARY

Achieving high-throughput, comprehensive analysis of single nanoparticles may facilitate the determination of their size, shape, and composition, which may be useful for understanding particle heterogeneity in applications such as drug delivery and environmental monitoring. Existing techniques may be limited by low throughput, prolonged trapping times, irreversible particle adsorption, and/or restricted characterization capabilities. The interferometric electrodynamic tweezers (IETs) described in this specification may incorporate an integrated platform that allows for the rapid trapping of single nanoparticles in parallel within approximately three seconds.

IET platforms may allow for the label-free characterization of particle size and shape via interferometric imagery and may support the identification of molecular composition via Raman spectroscopy, all without requiring fluorescent labeling. The capabilities of IET platforms may be demonstrated through the trapping and imaging of colloidal polymer beads, micro and nanoplastics, nanoscale extracellular vesicles (EVs), and recently identified extracellular nanoparticles known as supermeres. The sizes and/or shapes of EVs and/or supermeres, as well as micro and nanoplastics may be assessed by monitoring their interferometric contrast images while the particles are trapped. Thus, the IET platforms described herein may serve as versatile optofluidic systems for the comprehensive analysis and characterization of nanoscale objects, potentially advancing applications in nanomedicine, environmental monitoring, and other fields.

Understanding the heterogeneity of nanoscale biological objects, such as extracellular vesicles (EVs) and newly identified non-vesicular extracellular nanoparticles, may support advancements in nanomedicine, diagnostics, and environmental monitoring. However, current methods for manipulating, imaging, and analyzing these nanoscale objects may be limited by low throughput, complex workflows, or restricted characterization capabilities. Techniques such as anti-Brownian electrokinetic trapping, plasmonic nanotweezers, resonant dielectric nanoantenna traps, quasi-BIC metasurface tweezers, optothermoelectric tweezers, and photonic crystal cavity traps may facilitate nanoparticle trapping but may not provide the high-throughput, label-free, and comprehensive analysis needed to fully explore nanoparticle heterogeneity.

Label-free imaging technologies, such as interferometric scattering (iSCAT) and coherent bright-field imaging (COBRI), may serve as useful tools for visualizing nanoscale objects without perturbing their native states. These methods may rely on the interaction between a reference beam and the Rayleigh-scattered signal from subwavelength-scale targets, potentially allowing for rapid imaging while avoiding limitations associated with fluorescence-based techniques, such as photobleaching and labeling artifacts. In iSCAT microscopy, the backward-scattered light may interfere with a portion of the incident light reflected at the water-substrate interface, whereas COBRI may interfere the forward-scattered light with the transmitted incident light. Both iSCAT and COBRI may facilitate the study of particle dynamics with high temporal resolution. However, existing implementations may require particles to diffuse to and bind irreversibly to surfaces, which may introduce variability in particle analysis due to differences in diffusion times for particles of varying sizes and may limit reusability. For example, in the single-particle interferometric reflectance imaging sensor (SP-IRIS), particles may be irreversibly captured on antibody-functionalized surfaces, potentially necessitating new samples for each experiment.

Despite advancements in single-particle trapping and characterization, a scalable platform that may provide simultaneous high-throughput trapping, label-free imaging, and molecular composition analysis of individual nanoparticles remains challenging to achieve. Such a platform may support rapid and detailed characterization of both size and chemical composition at the nanoscale, which may have broad implications for fields such as nanomedicine and environmental science.

The interferometric electrohydrodynamic tweezers (IET) described in this specification may use electrohydrodynamic flows to rapidly trap thousands of nanoscale objects, such as EVs and nanoparticles, in parallel within seconds. This platform may integrate label-free interferometric imaging with molecular composition analysis via Raman spectroscopy, supporting precise, real-time characterization at the single-particle level without requiring fluorescent labels or surface immobilization. Additionally, IET may allow for the comprehensive analysis of nanoscale particles, including size, shape, and chemical composition, in their native state, potentially reducing artifacts associated with traditional staining or fixation techniques.

The versatility of the interferometric electrohydrodynamic tweezers (IET) described in this specification may be demonstrated through the rapid trapping and label-free imaging of colloidal polymer beads, extracellular vesicles (EVs), and newly identified extracellular nanoparticles, including supermeres. By monitoring interferometric contrast images, the size of these particles may be assessed while they remain freely suspended, which may offer advantages over conventional surface-bound techniques.

The interferometric electrohydrodynamic tweezers (IET) described in this specification may serve as a versatile platform for nanoscale particle trapping and characterization, potentially supporting high-throughput analysis of biological and synthetic nanoparticles. This approach may have broad applications in fields such as nanomedicine, drug delivery, and environmental monitoring.

Single-particle tracking and analysis in microfluidic trapping environments with structured electrode surfaces may involve complex imaging conditions in which manual identification or conventional algorithmic methods may be slow or unreliable, potentially reducing the throughput and scalability of nanoparticle characterization workflows. The IET platform described in this specification may integrate a trained neural network, such as a U-Net convolutional neural network with an encoder-decoder architecture and skip connections, to automatically segment and detect individual nanoscale particles in interferometric imagery. The trained neural network may generate segmentation masks from which particle centroids are extracted and tracked across consecutive image frames, supporting automated construction of spatiotemporal trajectories and extraction of diffusion coefficients for individual particles.

Characterizing the size and composition of nanoscale particles may not, by itself, distinguish true extracellular vesicles from non-vesicular contaminants, such as protein aggregates, within a heterogeneous sample, potentially reducing confidence in sample purity assessments. The IET platform described in this specification may determine the refractive index of individual trapped nanoscale particles by mapping interferometric contrast information and particle size information derived from Brownian motion analysis against simulated scattering cross-section curves corresponding to a plurality of refractive index values. Particles exhibiting refractive indices outside an expected range for extracellular vesicles may be identified as likely contaminants, supporting assessment of sample purity and heterogeneity at the single-particle level.

A trapped particle population may include a mixture of target vesicles and smaller contaminants, such as free proteins or extracellular RNA fragments, and selectively separating particles by size within a trapping environment may be challenging. The IET platform described in this specification may sort trapped nanoscale particles by size by varying the frequency of the alternating current applied across the electrodes. Increasing the applied frequency may progressively weaken the particle-surface interaction force that stabilizes out-of-plane confinement, preferentially releasing smaller particles from the trapping sites while retaining larger particles. In some examples, the applied frequency may be varied between approximately 1 kilohertz and approximately 30 kilohertz to achieve size-selective sorting.

Milk-derived extracellular vesicles (mEVs) represent a scalable source for therapeutic applications due to the abundance and accessibility of bovine milk. However, the isolation of mEVs with sufficient purity may be complicated by the presence of casein micelles and other protein contaminants in milk. The IET platform described in this specification may be applied to characterize mEVs that have been isolated via a purification protocol that includes acidification of bovine milk to precipitate casein proteins followed by differential ultracentrifugation. The IET platform may characterize such mEVs by determining at least one of size, refractive index, and sample purity in a label-free manner, supporting investigations into mEV heterogeneity and their use as therapeutic delivery vehicles.

The IET platform may also be applied to the analysis of micro and nanoplastics in different sources such water and biofluids. The IET platform may be used to trap micro and nanoplastics in parallel, identify their size, refractive index and chemical composition. For some modalities, the chemical position of the trapped microplastics may be determined from their Raman chemical fingerprint. Once this is established, the refractive index may then be assigned, given it is known for a given plastic polymer type. The assigned refractive index may then be used to accurately determine the size of trapped micro and nanoplastics from their interferometric contrast images.

According to some examples, a system includes a nanotweezer including a first electrode and a second electrode, the nanotweezer configured to generate electrohydrodynamic flows between the first electrode and the second electrode to trap nanoscale particles, a first coherent light source configured to illuminate the trapped nanoscale particles, a second coherent light source configured to illuminate the trapped nanoscale particles, a first sensor configured to monitor a first interaction between the first coherent light source and the trapped nanoscale particles, a second sensor configured to monitor a second interaction between the second coherent light source and the trapped nanoscale particles, and an electronic processor configured to determine particle sizes of the trapped nanoscale particles based on sensor signals from the first sensor and determine compositions of the trapped nanoscale particles based on sensor signals from the second sensor.

In other features, the first sensor is an imaging sensor configured to capture interferometric contrast images of the trapped nanoscale particles. In other features, the first sensor is a complementary metal-oxide-semiconductor sensor. In other features, the first coherent light source is configured to emit a first laser having a frequency of about 520 nanometers. In other features, the electronic processor is configured to determine particle shapes of the trapped nanoscale particles based on sensor signals from the first sensor. In other features, the electronic processor is configured to determine particle sizes of the trapped nanoscale particles based on elastic scattering as indicated by sensor signals from the first sensor.

In other features, the electronic processor is configured to determine particle sizes of the trapped nanoscale particles based on scattering contrast as indicated by sensor signals from the first sensor. In other features, the electronic processor is configured to determine particle shapes of the trapped nanoscale particles based on interferometric contrast as indicated by sensor signals from the first sensor. In other features, the second coherent light source is configured to emit a second laser having a frequency of about 785 nanometers. In other features, the electronic processor is configured to determine chemical compositions of the trapped nanoscale particles based on sensor signals from the second sensor.

In other features, the electronic processor is configured to determine molecular compositions of the trapped nanoscale particles based on sensor signals from the second sensor. In other features, the electronic processor is configured to determine compositions of the trapped nanoscale particles based on inelastic scattering as indicated by sensor signals from the second sensor. In other features, the electronic processor is configured to determine compositions of the trapped nanoscale particles based on Raman scattering as indicated by sensor signals from the second sensor. In other features, the first electrode includes an array of micron-scale holes.

In other features, the first electrode includes a gold material. In other features, the second electrode includes a transparent material. In other features, the second electrode includes an indium tin oxide material. In other features, the nanotweezer includes a microfluidic channel formed between the first electrode and the second electrode. In other features, the nanotweezer includes a voltage source electrically coupled to the first electrode and the second electrode. In other features, the voltage source is configured to apply an alternating current having a frequency in a range of between about 1 kilohertz and 10 kilohertz between the first electrode and the second electrode.

In other features, the electronic processor is configured to execute a trained neural network comprising an encoder-decoder architecture with skip connections to generate segmentation masks identifying locations of individual trapped nanoscale particles in imagery captured by the first sensor, extract particle centroids from the segmentation masks, and construct particle trajectories across consecutive image frames.

In other features, the voltage source is configured to temporarily deactivate the alternating current to release the trapped nanoscale particles, and the electronic processor is configured to track motion of the released nanoscale particles via the first sensor, extract diffusion coefficients from the tracked motion, and determine particle sizes of the released nanoscale particles based on the extracted diffusion coefficients.

In other features, the voltage source is configured to vary a frequency of the alternating current to sort the trapped nanoscale particles by size, wherein increasing the frequency preferentially releases smaller nanoscale particles from trapping sites while retaining larger nanoscale particles.

Other examples, embodiments, features, and aspects will become apparent by consideration of the detailed description and accompanying drawings.

### BRIEF DESCRIPTION OF THE DRAWINGS

FIG. 1 is a block diagram illustrating a system for trapping and analyzing nanoscale particles, according to some examples.

FIG. 2 is a cross-sectional view of a nanotweezer device, according to some examples.

FIG. 3 is a rendering and schematic diagram illustrating examples of the system of FIG. 1, according to some examples.

FIG. 4 is a series of images and a chart illustrating examples of the working principles of the interferometric electrohydrodynamic tweezer (IET) system of FIG. 1 and scattering simulations for 300 nm spherical and elliptical nanoparticles, according to some examples.

FIG. 5 includes a series of schematic diagrams and images illustrating the rapid parallel trapping and label-free imaging of dielectric nanoparticles using the interferometric electrohydrodynamic tweezers (IET) system of FIG. 1, according to some examples.

FIG. 6 includes a series of images and charts illustrating examples of comprehensive size and chemical composition analysis of polystyrene (PS) bead particles using the IET system of FIG. 1, according to some examples.

FIG. 7 includes schematic illustrations, images, and charts that describe label-free imaging and size estimation of extracellular vesicles (EVs) and supermeres using the IET system of FIG. 1, according to some examples.

FIG. 8 illustrates conceptual schematics for electrohydrodynamic trapping, interferometric imaging, and machine learning architecture for analysis of milk-derived extracellular vesicles using the system of FIG. 1, according to some examples.

FIG. 9 illustrates schematics, charts, and images describing the isolation and purification of milk-derived extracellular vesicles and validation of sample purity, according to some examples.

FIG. 10 illustrates images and charts showing label-free detection of single EVs and calibration of vesicle size using the system of FIG. 1, according to some examples.

FIG. 11 illustrates frames showing a sorting experiment of multiple EVs using the system of FIG. 1, according to some examples.

FIG. 12 is a diagram illustrating the in-plane AC electro-osmotic flow distribution within the nanotweezer device of FIG. 1, according to some examples.

FIG. 13 is a schematic diagram illustrating AC electro-osmotic flow trapping and label-free detection within the nanotweezer device of FIG. 1, according to some examples.

FIG. 14 is a schematic diagram illustrating a background subtraction procedure from a raw image to a contrast-enhanced image, according to some examples.

FIG. 15 is a chart illustrating the evolution of the binary cross-entropy loss for a particle-segmentation model, according to some examples.

FIG. 16 illustrates charts showing the mean-squared displacement (MSD) of particles as a function of lag time, according to some examples.

In the drawings, reference numbers may be reused to identify similar and/or identical elements.

### DETAILED DESCRIPTION

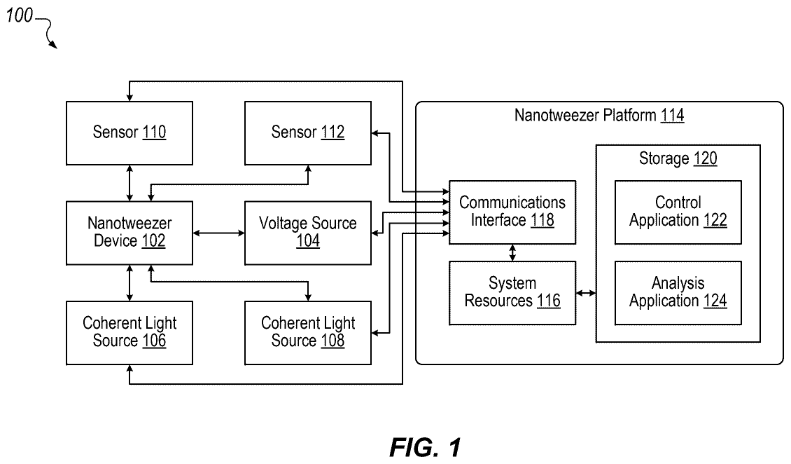

FIG. 1 is a block diagram illustrating a system 100 for trapping and analyzing nanoscale particles, according to some examples. In this example, the system 100 includes a nanotweezer device 102, a voltage source 104, a coherent light source 106, a coherent light source 108, a sensor 110, a sensor 112, and a nanotweezer platform 114. In other examples, the system 100 may include a different combination of components, including omitted or duplicated components as may be appropriate. The system 100 may implement various examples of the IET system or IET platform described herein.

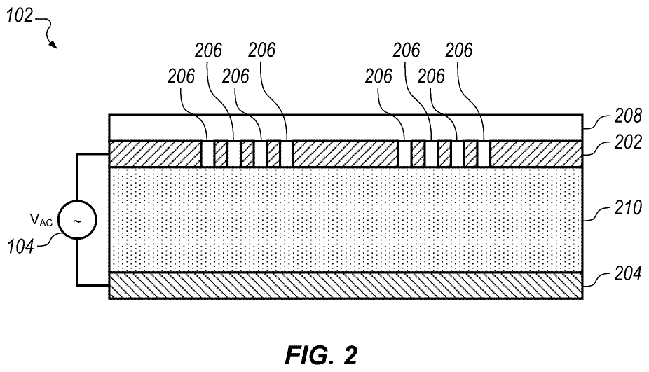

FIG. 2 is a cross-sectional view of the nanotweezer device 102, according to some examples. Referring collectively to FIGS. 1 and 2, the nanotweezer device 102 may include a top electrode 202 positioned opposite a bottom electrode 204. The top electrode 202 may contain an array of micron-scale holes 206 formed through its structure. This top electrode 202 may be deposited on a dielectric spacer layer 208, which, together with the bottom electrode 204, defines a microfluidic channel 210. This microfluidic channel 210 may be filled with a fluidic medium, allowing nanoparticles to be suspended and transported.

The top electrode 202 may be positioned within the microfluidic channel 210 and may be formed from a thin metal film, such as gold, or other conductive materials, including platinum, silver, or aluminum. The thin metal film of the top electrode 202 may be deposited on a substrate. In some examples, the substrate may be SiO₂. In other examples, particularly where higher laser powers are employed and photothermal heating at the trapping sites may be a concern, the substrate may be a material having a higher thermal conductivity compared to SiO₂ to dissipate photothermal heating. Suitable higher thermal conductivity substrate materials may include silicon, aluminum nitride (AlN), silicon carbide (SiC), diamond, or other thermally conductive substrates. The selection of a substrate material with higher thermal conductivity may reduce localized temperature increases caused by absorption of laser light in the thin gold film, supporting stable trapping conditions and reducing the risk of thermal damage to the sample or the trapped nanoscale particles. The bottom electrode 204 may be formed from a substantially transparent conductive material, such as indium tin oxide (ITO), fluorine-doped tin oxide (FTO), or graphene-based conductive films. The dielectric spacer layer 208 may be composed of a non-conductive material, such as glass, quartz, or polymeric materials (e.g., PDMS or SU-8 resins).

In some examples, the nanotweezer device 102 may be implemented as a nanotweezer chip. The nanotweezer chip may include the top electrode 202 having the array of micron-scale holes 206, the bottom electrode 204, and the dielectric spacer layer 208 defining the microfluidic channel 210. The nanotweezer chip may be a self-contained, integrated device in which these components are assembled into a single chip-scale package suitable for mounting on a microscope stage or other optical platform.

The nanotweezer chip may also include tubes connected to the microfluidic channel 210 to allow pumping of fluid through the channel containing the microhole array using a pump. The pump may be a syringe pump, a peristaltic pump, or other suitable fluid-handling device. The tubes may allow for the introduction of sample fluid containing nanoscale particles into the microfluidic channel 210, the exchange or replenishment of the fluidic medium during an experiment, and the removal of waste fluid following analysis. In some examples, the tubes may be connected at opposing ends of the microfluidic channel 210 to establish a continuous flow path through the channel containing the micron-scale holes 206.

The voltage source 104 may be electrically coupled to the top electrode 202 and the bottom electrode 204. The voltage source 104 may apply an alternating current (AC) electric field at frequencies between about 1 kilohertz (kHz) and about 30 kHz across the electrodes. At frequencies between about 1 kHz and about 10 kHz, the AC electric field may induce electro-osmotic flow within the microfluidic channel 210, generating localized stagnation zones near the top electrode 202, particularly between the micron-scale holes 206, where nanoscale particles may be trapped and analyzed. At higher frequencies within this range, the particle-surface interaction force that stabilizes out-of-plane confinement may progressively weaken, and the voltage source 104 may vary the frequency of the alternating current to preferentially release smaller nanoscale particles from trapping sites while retaining larger nanoscale particles, thereby sorting the trapped nanoscale particles by size.

In other examples, the connection of the voltage source 104 may be configured such that the voltage source 104 is applied between the top electrode 202 and the dielectric spacer layer 208, rather than between the top electrode 202 and the bottom electrode 204. In such a configuration, the electric field distribution within the microfluidic channel 210 may be altered, and the nanoscale particles may be trapped at the microhole region defined by the micron-scale holes 206 in parallel. This alternative electrode configuration may modify the spatial distribution of the AC electro-osmotic flows and the resulting stagnation zones, potentially supporting different trapping geometries or trapping characteristics relative to the configuration in which the voltage source 104 is applied between the top electrode 202 and the bottom electrode 204.

The coherent light source 106 may emit a coherent light beam, such as a laser, through the bottom electrode 204 to illuminate the trapped nanoscale particles. For example, the coherent light source 106 may emit a laser with a wavelength of approximately 520 nanometers, which may induce elastic scattering from the trapped nanoscale particles. In other examples, the coherent light source 106 may include a light-emitting diode (LED) as the illumination source. An LED-based illumination source may provide a broadband or narrowband illumination alternative to a laser, and may be selected based on the desired imaging modality, cost considerations, or application-specific requirements.

The sensor 110 may include an imaging sensor, such as a CMOS or CCD sensor, or other suitable optical detectors capable of capturing images based on scattering contrast, interferometric contrast, or other optical properties of the trapped nanoscale particles as they interact with the coherent light from the coherent light source 106.

The coherent light source 108 may emit a coherent light beam, such as a laser, through the bottom electrode 204 to excite the trapped nanoscale particles. For example, the coherent light source 108 may emit a laser with a wavelength of approximately 785 nanometers, which may induce inelastic scattering, such as Raman scattering, from the trapped nanoscale particles. In some examples, the coherent light source 108 may serve as both a trapping laser and a Raman excitation laser. In such a configuration, the same laser used to perform optical trapping of nanoscale particles at a designated trapping site may also be used to induce Raman scattering from the trapped particles for molecular composition analysis. The wavelength of the coherent light source 108 is not limited to approximately 785 nanometers and may include other wavelengths suitable for combined optical trapping and Raman excitation, such as approximately 1064 nanometers, approximately 630 nanometers, or other wavelengths selected based on the optical properties of the target nanoscale particles, the desired Raman spectral range, and compatibility with the optical components of the system 100.

The sensor 112 may include a spectroscopic detector, such as a CCD array, photomultiplier tube (PMT), or other Raman-sensitive optical sensor, capable of detecting Raman spectral signals emitted by the trapped nanoscale particles in response to the excitation from the coherent light source 108.

The nanotweezer platform 114 may be implemented as a computing platform that includes system resources 116, a communications interface 118, and storage 120. The system resources 116 may include one or more electronic processors and/or graphics processing units (GPUs) configured to execute instructions stored in storage 120. Additionally, the system resources 116 may incorporate volatile memory (e.g., RAM, etc.), non-volatile memory (e.g., flash storage, solid-state drives, hard-disk drives, etc.), and/or system buses that interconnect various components of the nanotweezer platform 114 (such as any of the previously described devices).

The communications interface 118 may facilitate data exchange between the nanotweezer platform 114 and other system components, such as, for example, the voltage source 104, coherent light source 106, coherent light source 108, sensor 110, and/or sensor 112. The communications interface 118 may allow the nanotweezer platform 114 to transmit control signals to these components and receive sensor data for processing and analysis.

The storage 120 may contain software applications, such as, for example, a control application 122 and an analysis application 124. The control application 122 may regulate various system operations, such as adjusting the amplitude and frequency of the AC waveform generated by the voltage source 104, controlling the wavelength and intensity of coherent light sources 106 and/or 108, and/or managing the operating states of sensors 110 and/or 112. The control application 122 may further implement a sorting mode in which the frequency of the AC waveform generated by the voltage source 104 is selectively varied to achieve size-based separation of trapped nanoscale particles. In various implementations, the control application 122 may increase the applied frequency from an initial trapping frequency to a higher sorting frequency, such as from approximately 10 kilohertz to approximately 30 kilohertz, to preferentially release smaller particles from trapping sites.

The analysis application 124 may process data from sensors 110 and 112 to characterize the trapped nanoscale particles. For instance, the analysis application 124 may determine particle size and shape based on elastic scattering detected by sensor 110, analyzing properties such as scattering contrast and interferometric contrast resulting from the interaction between trapped particles and the coherent light emitted by coherent light source 106. Additionally or alternatively, the analysis application 124 may identify the chemical and molecular composition of trapped nanoparticles based on inelastic scattering (e.g., Raman scattering) detected by sensor 112, following excitation by coherent light source 108.

The analysis application 124 may further include a trained neural network configured to segment and detect individual nanoscale particles in imagery captured by the sensor 110. The trained neural network may include an encoder-decoder architecture with skip connections, such as a U-Net convolutional neural network, and may generate segmentation masks identifying locations of individual nanoscale particles within the imagery. The analysis application 124 may extract particle centroids from the segmentation masks and construct particle trajectories across consecutive image frames, supporting automated extraction of diffusion coefficients for individual particles.

In various implementations, the analysis application 124 may determine refractive indices of trapped nanoscale particles by comparing interferometric contrast information from the sensor 110 with particle size information derived from Brownian motion analysis. The analysis application 124 may map the interferometric contrast information and the particle size information against simulated scattering cross-section curves corresponding to a plurality of refractive index values to estimate the refractive index of each trapped particle. The determined refractive indices may support assessment of sample purity, where particles exhibiting refractive indices outside an expected range for extracellular vesicles may be identified as non-vesicular contaminants such as protein aggregates.

Furthermore, the control application 122 and the analysis application 124 may implement additional functionalities described elsewhere in this specification, as appropriate, including controlling any of the components of the system 100 to perform any of the techniques, methods, or operational modes described herein.

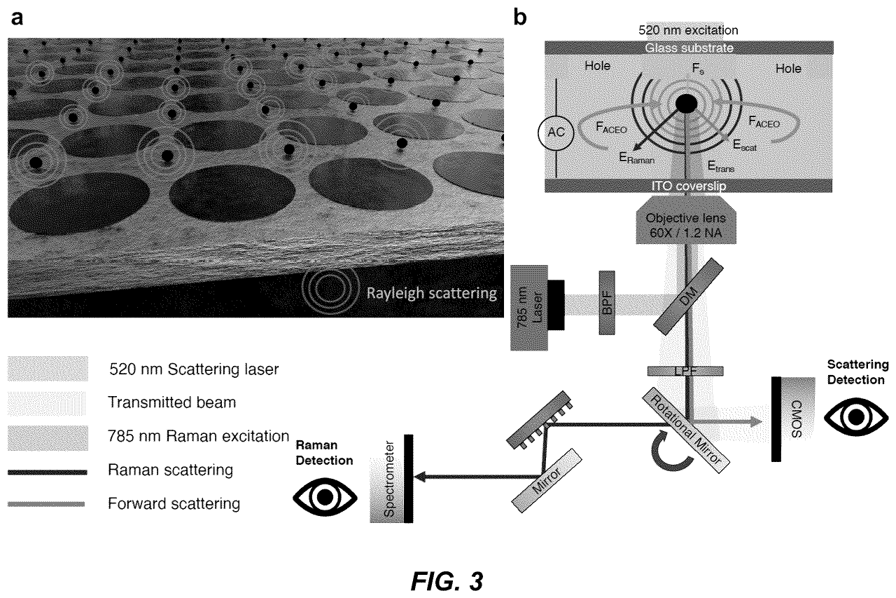

FIG. 3 is a rendering and schematic diagram illustrating examples of the system 100, according to some examples. The interferometric electrohydrodynamic tweezers (IET) platform described in this specification, as illustrated in FIG. 3 (at a), may include a gold film patterned with an array of micron-scale holes, which may be fabricated via photolithography to support scalable wafer-scale large-area sample production as needed. A bottom electrode, which may be composed of materials such as indium tin oxide (ITO), may be positioned above the patterned gold film with a dielectric spacer layer in between. The chip may be mounted on a custom microscope setup, as depicted in FIG. 3 (at b). The dielectric spacer layer may define the microfluidic channel, which may house the micron-scale hole array and the fluidic medium.

FIG. 3 further illustrates the working principle of the interferometric electrohydrodynamic tweezers (IET) system 100, according to some examples. FIG. 3 (at a) illustrates a schematic representation of the IET system 100, which may allow for the rapid parallel trapping of multiple nanoparticles and label-free interferometric imaging. FIG. 3 (at b) includes an illustration of the working principle and experimental setup of the IET system 100. Nanoparticles may be transported via in-plane AC electro-osmotic (ACEO) flow and may be trapped at the nearest stagnation zones. Forces acting on the particles may include F_{ACEO}, the drag force from ACEO flow, and Fₛ, the particle surface interaction force. Optical signals involved may include E_{scat}, the scattered electric field from the particle; E_{Raman}, the Raman signal from the particle; and Eₜᵣₐₙₛ, the transmitted light after passing through the thin gold film. Optical components may include: DM, a dichroic mirror; BPF, a band-pass filter; and LPF, a long-pass filter.

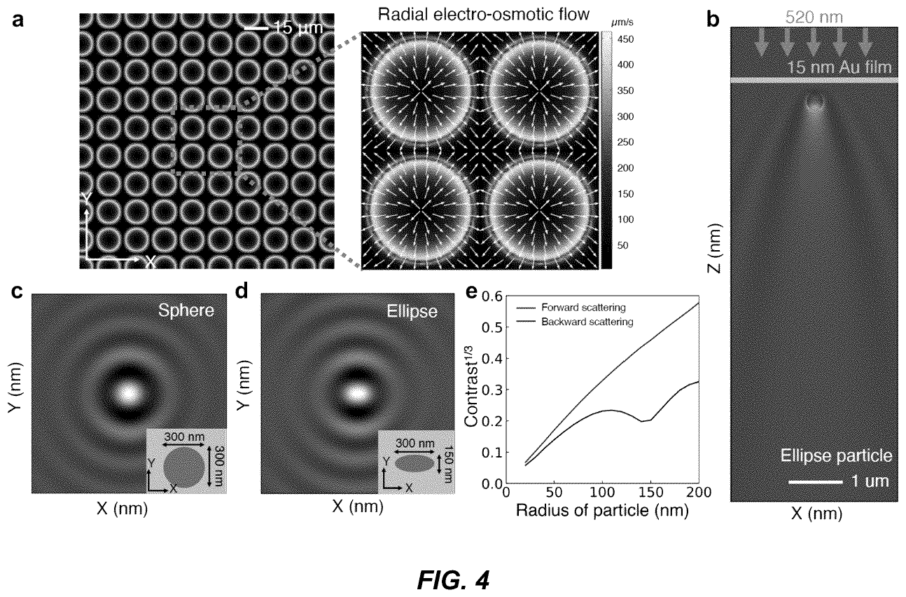

FIG. 4 is a series of images and a chart illustrating examples of the working principles of the interferometric electrohydrodynamic tweezer (IET) system 100 and scattering simulations for 300 nm spherical and elliptical nanoparticles, according to some examples. When an alternating current (AC) voltage with a frequency ranging from approximately 1 kHz to 10 kHz is applied across the patterned gold film, both normal and tangential AC electric fields may be generated. The tangential AC electric field may interact with the electric double layer (EDL) charges induced at the interface between the gold film and the adjoining fluid medium, leading to surface AC electro-osmotic (ACEO) flows. The flow velocity may be defined by the Helmholtz-Smoluchowski slip velocity, with its magnitude expressed by Equation (1) below:

$${u}_{s} = - \frac{{ε}_{w} ζ}{η} {E}_{∥} \qquad ( 1 )$$

In Equation (1), uₛ represents the velocity of the ACEO flow, ε_{w} is the permittivity of the fluid medium, ζ is the zeta potential, η is the fluid viscosity, and E_{∥} is the tangential component of the electric field established near the gold-fluid interface.

The induced ACEO flow field vectors may converge at the center of the unpatterned regions of the gold film, forming stagnation zones where the in-plane fluid velocity approaches zero, as depicted in FIG. 4 (at a). These stagnation zones may serve as regions where single nanoscale objects may be localized. The localization of particles in the out-of-plane direction may be influenced by the particle-surface interaction force, which may arise from interactions between the double-layer charge on the particle and its image charge in the conductive plane.

Once trapped at designated trapping sites, nanoparticles may be imaged without requiring attachment to the gold surface or the use of fluorescent labels by employing interferometric imaging. To achieve this, an imaging laser beam with a wavelength of approximately 520 nm may illuminate the sample from above, allowing some of the light to transmit through the gold film. A portion of this transmitted light may be scattered by the trapped particles before reaching the detector. The detected light, which may consist of both transmitted and scattered components, may be described by Equation (2):

I_{det}=|Eₜᵣₐₙ+E_{scat}|²=|E_{inc}|²(t²+|s|²+2t|s|cosθ) (2)

In Equation (2), Eₜᵣₐₙ represents the transmitted electric field, E_{scat} represents the scattered electric field, t is the transmission coefficient, |s|² is the scattering cross-section of the particle in the medium, and θ is the phase difference between the scattered light and the light transmitted through the thin gold film.

The intensity normalization between the detected and incident transmitted light, expressed as

$$\frac{{I}_{det}}{{I}_{t r a n}} ,$$

may define the contrast following the imaging process. This contrast term may be represented by Equation (3):

$$C = {( \frac{\vert s \vert}{t} )}^{2} + 2 \frac{\vert s \vert}{t} = ( \frac{1}{t} ) {σ}_{scat} + 2 ( \frac{1}{t} ) \sqrt{{σ}_{scat}} \qquad ( 3 )$$

In Equation (3), σ_{scat} denotes the scattering cross-section from the particle.

FIG. 4 (at a) illustrates an electrohydrodynamic simulation depicting how the interferometric electrohydrodynamic tweezers (IET)-induced radial AC electro-osmotic (ACEO) flow field may converge radially, establishing stagnation zones at the center of four adjacent holes where nanoparticles may be trapped. FIG. 4 (at b) illustrates a finite-difference time-domain (FDTD) simulation showing the intensity of scattered light along the out-of-plane direction, normalized by the background field transmitted through a 15 nm thin gold film.

FIG. 4 (at c and d) illustrate the intensity of scattered light, normalized by the background field along the in-plane direction, highlighting differences in scattering patterns for nanoparticles with varying shapes. FIG. 4 (at c) shows the scattering pattern for a 300 nm diameter spherical particle, while FIG. 4 (at d) depicts the pattern for an elliptical particle with a length of approximately 150 nm along the Y-axis. The insets in both figures provide cross-sectional views of the respective particle shapes.

FIG. 4 (at e) presents a simulated contrast of forward and backward scattering as a function of particle size, according to some examples. FIG. 4 (at e) illustrates that forward Mie scattering may become increasingly dominant as particle size increases. This trend may be advantageous for the IET platform, which collects forward-scattered photons, potentially allowing for the correlation of particle size with contrast, even for larger particles.

In the IET platform, forward-scattered light may contribute to enhanced image contrast after background transmitted light is removed, as illustrated in FIG. 4 (at b) (see methods section for details). FIG. 4 (at c and d) depict interferometric contrast images of particles with varying shapes, ranging from spherical to ellipsoidal. These results suggest that particle shape may be inferred based on interferometric imaging within the IET chip.

Interferometric scattering (iSCAT) techniques may typically operate in reflection mode, where particles or molecules are positioned on a substrate with weak reflectivity, such as glass. In such configurations, the detector may collect backscattered light from the adsorbed particles. It has been observed that contrast generated by backscattered photons may not exhibit a linear relationship with particle size, as represented by the lower curve in FIG. 4. In contrast, the IET platform described in this specification may operate in transmission mode, where forward-scattered light is collected by the detector, similar to coherent bright-field imaging. The contrast associated with forward-scattered light may exhibit a more linear relationship with particle size, as shown by the red curve in FIG. 4 (at e) (see Methods section). This trend may occur because forward scattering may become increasingly dominant as particle size approaches half the wavelength of the incident light. By operating in transmission mode, the IET platform may facilitate the collection of forward-scattered photons, which may support accurate size determination through interferometric contrast analysis. Additionally, after characterizing the particle size, Raman spectroscopy may be performed to assess the molecular composition of the trapped nanoparticles (see Methods section for details).

The IET platform described in this specification may facilitate the rapid parallel trapping and label-free imaging of extracellular vesicles (EVs), supermeres, and dielectric beads. The platform, which may be fabricated using photolithography (see methods section for details), may span an area of approximately 8 mm by 4 mm and may contain an array of approximately 60,000 trapping sites. These sites may be defined by 15 μm-diameter holes arranged with a periodicity of approximately 18 μm. The IET platform may incorporate a 15 nm-thick gold (Au) film, which may provide sufficient electrical conductivity for generating tangential electric fields and in-plane AC electro-osmotic (ACEO) flow. This film thickness may also allow for sufficient optical transmission to facilitate light scattering by the trapped nanoscale particles. The chip may be fabricated using photolithography to support large-scale patterning.

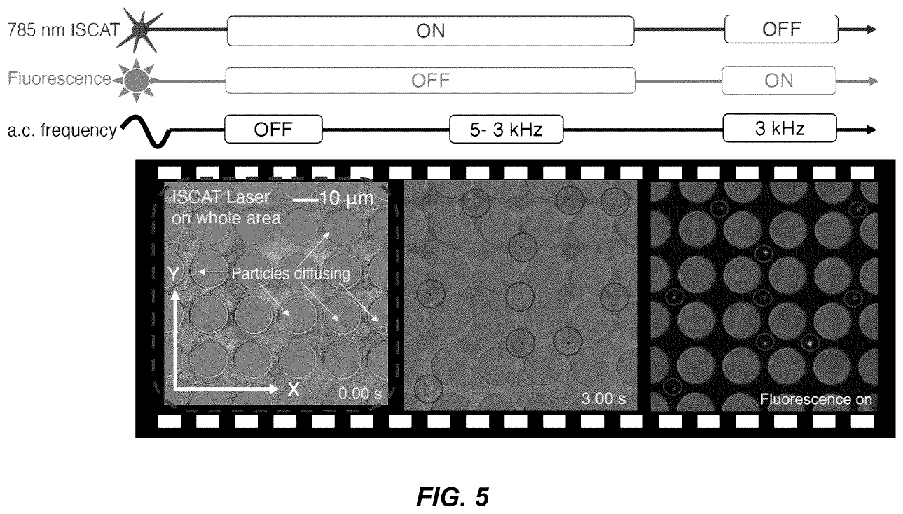

To evaluate the trapping and label-free imaging capabilities of the IET system, 300 nm dielectric beads were introduced into a microfluidic channel integrated with the IET patterns. An AC voltage of approximately 10 V at a frequency of 3 kHz may be applied, generating parallel ACEO flows near the trapping sites. These flows may rapidly transport and trap particles at designated trapping sites within approximately three seconds, as illustrated in FIG. 5.

FIG. 5 includes a series of schematic diagrams and images illustrating the rapid parallel trapping and label-free imaging of dielectric nanoparticles using the interferometric electrohydrodynamic tweezers (IET) system 100, according to some examples. Frame-by-frame images in FIG. 5 may depict the trapping of 300 nm polystyrene (PS) beads in parallel within seconds, alongside label-free imaging. The interferometric (label-free) images obtained using the IET platform may exhibit strong agreement with fluorescent imaging results, highlighting the platform's potential for high-throughput, label-free particle analysis.

The imaging process described in this specification may proceed as follows. First, the acquired video may be processed by calculating the mean pixel intensity to generate an average frame, which may then be used to normalize each frame to remove the background. This normalization step may enhance contrast between the transmitted light and the light scattered by the trapped particles, potentially allowing the scattering signal from individual nanoscale particles to be detected with greater precision. For a 60×, 1.2 NA objective lens, the field of view (FOV) may be approximately 80 μm×80 μm, which may accommodate around 25 IET trapping sites within the FOV.

At this stage, the system described in this specification may provide flexibility to perform one or more of the following tasks: (1) record the interferometric contrast of trapped particles at each site; (2) temporarily release particles and track their Brownian motion to estimate size based on Brownian diffusion and correlate this with interferometric contrast; and (3) illuminate a specific particle at a designated IET trapping site to further stabilize it using optical gradient forces in conjunction with the IET trapping potential, allowing for the collection of its Raman signal to assess molecular composition without disturbing particles in other trapping sites. These capabilities may represent an advancement over prior optical nanotweezers by supporting size and chemical composition characterization in a label-free manner within a single integrated platform.

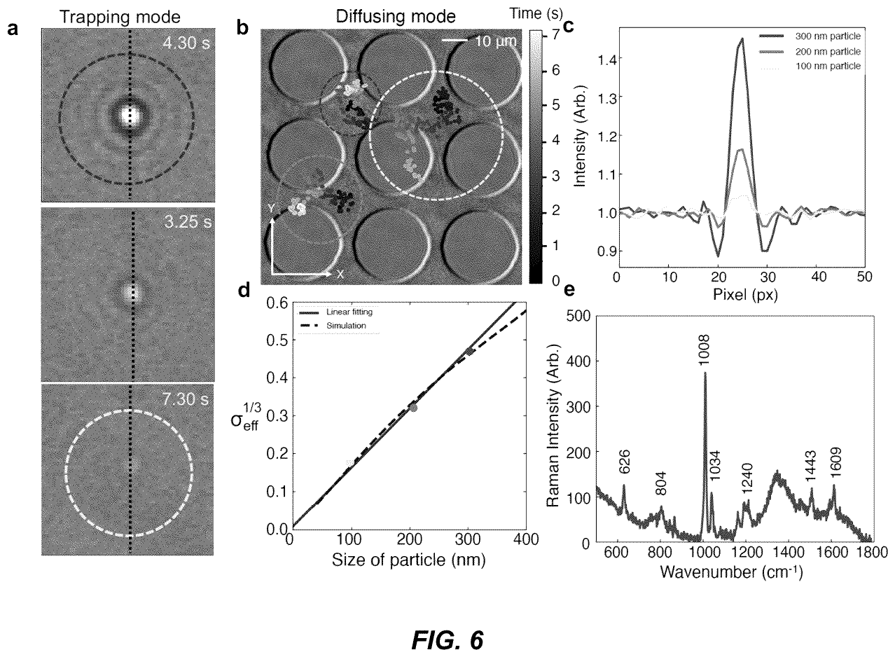

FIG. 6 includes a series of images and charts illustrating examples of comprehensive size and chemical composition analysis of polystyrene (PS) bead particles using the IET system 100, according to some examples. FIG. 6 (at a) depicts trapped particles of various sizes, with contrast information extracted during trapping. Dotted circles may indicate trapped particles with diameters of approximately 300 nm, 200 nm, and 100 nm, respectively. FIG. 6 (at b) illustrates the release of particles by deactivating the applied AC voltage, allowing for the analysis of Brownian motion. Dotted circles may show the diffusion trajectories of particles after release, and the Brownian diffusion coefficient may be estimated based on the mean square displacement (MSD) analysis. FIG. 6 (at c) presents the brightness intensity along the black dotted line in FIG. 6 (at a), quantifying the contrast for each particle size. FIG. 6 (at d) illustrates the effective contrast raised to the power of one-third, which may exhibit a quasi-linear relationship with particle size, represented by the continuous line. The dotted line may indicate contrast variations based on forward scattering simulations. FIG. 6 (at e) shows Raman spectral measurements of trapped polystyrene particles obtained during IET operation, highlighting the characteristic 1008 cm⁻¹ Raman peak of polystyrene.

FIG. 6 (at a) illustrates that the interferometric contrast may decrease as particle size decreases. In cases where particle size is not known beforehand, the size of trapped particles may be independently determined by monitoring their Brownian motion after they are released from the IET traps. To illustrate this process, a mixture of 100 nm, 200 nm, and 300 nm polystyrene (PS) beads was introduced into the system. Following trapping, the AC field may be temporarily turned off to release the particles, allowing their Brownian motion to be tracked, as shown in FIG. 6 (at b). During this diffusion phase, particles of different sizes may undergo Brownian dynamics in the medium. The diffusion coefficient may be calculated using Equation (4):

D=MSD(τ)/2dt (4)

In Equation (4), D represents the diffusion coefficient, τ is the lag time, and d is the dimensional factor, which is 2 in some examples. By analyzing the diffusion dynamics, the size information of the trapped particles may be obtained (see methods section for details). Through mean square displacement (MSD) calculations, the slopes of the linear fits of the MSD data may indicate Brownian diffusion coefficients of approximately 5.4 μm²/s, 7.91 μm²/s, and 16.9 μm²/s, corresponding to estimated PS bead diameters of approximately 302.2 nm, 207.2 nm, and 96.6 nm, respectively. These estimates closely align with the predefined sizes of the PS beads (such as, for example, 300 nm, 200 nm, and 100 nm in diameter). Additionally, during the trapping phase illustrated in FIG. 6 (at a), interferometric contrast information from the nanoparticles may be correlated with particle size. FIG. 6 (at c) presents the brightness intensity profile across the center of the Airy disk, as indicated by the black dotted line in the insets of FIG. 6 (at a). Here, the standard deviation of intensity measurements may be used to quantify contrast variations for different particle sizes (see methods section for details).

The relationship between particle size estimated from Brownian motion and the cube root of interferometric contrast may be analyzed, as shown in FIG. 6 (at d). The results suggest that the cube root of the standard deviation of interferometric contrast may exhibit a linear correlation with particle size, as indicated by the red line. Additionally, contrast values derived from forward-scattering finite-difference time-domain (FDTD) simulations may closely correspond to particle size, as depicted by the dotted line (see methods section for details). Once a calibration relationship has been established, particle size may be determined by imaging its interferometric contrast across the IET chip.

The IET platform may also support the detection of chemical composition in trapped particles. FIG. 6 (at e) presents a Raman spectrum obtained from polystyrene beads trapped at an IET site and illuminated with a 785 nm Raman laser beam. The spectrum may exhibit characteristic peaks, including a dominant peak at approximately 626 cm⁻¹ corresponding to the C-C stretching mode, a peak at approximately 804 cm⁻¹ associated with C-H out-of-plane deformation, and a peak at approximately 1008 cm⁻¹ representing the ring breathing mode. Additional peaks at approximately 1034 cm⁻¹, 1443 cm⁻¹, and 1609 cm⁻¹ may correspond to in-plane C-H bending of phenyl rings, C-H bending vibrations, and C-C stretching vibrations within the phenyl ring, respectively.

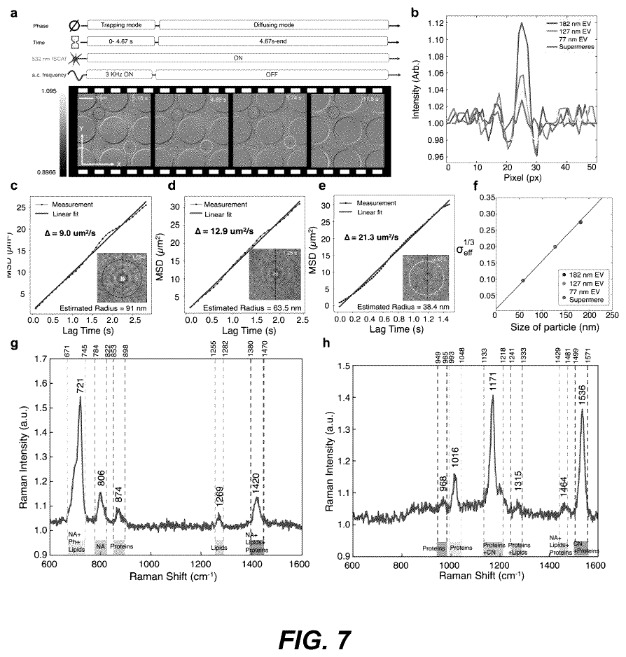

FIG. 7 includes schematic illustrations, images, and charts that describe label-free imaging and size estimation of extracellular vesicles (EVs) and supermeres using the IET system 100, according to some examples. FIG. 7 (at a) depicts sequential images illustrating the trapping and release of EVs in trapping and diffusion modes. FIG. 7 (at b) presents a brightness intensity plot along the black dotted line (inset in FIG. 7 (at c, d, and e), showing the relative intensity of trapped EVs and supermeres. FIG. 7 (at c-e) display mean square displacement (MSD) calculations based on Brownian motion dynamics, with linear regression indicated by the red line. FIG. 7 (at f) shows that the effective contrast raised to the power of one-third may exhibit a quasi-linear relationship with the particle size of EVs and supermeres. FIG. 7 (at g and h) illustrate Raman spectra obtained from trapped EV1 and EV2, where distinct Raman peaks may provide insights into their molecular composition.

A series of experiments were conducted to evaluate the capability of the IET platform for trapping and label-free imaging of extracellular vesicles (EVs) and the recently identified extracellular nanoparticles known as supermeres, without the need for fluorescent labeling. FIG. 7 (at a) illustrates a frame-by-frame sequence of EV trapping and label-free imaging of the trapped EVs. Given the heterogeneous size distribution of EVs, it is expected that EVs of varying sizes may be trapped at different trapping sites. The interferometric contrast images exhibit differences corresponding to variations in EV size at distinct trapping sites.

To independently estimate EV sizes and establish a calibration plot correlating contrast images with size, EVs were released by temporarily turning off the applied AC field, allowing their Brownian motion to be tracked, similar to the procedure used for polystyrene beads. The Brownian trajectories of three EVs were tracked, with their movements in two-dimensional space indicated by dotted lines. Particle localization was monitored over approximately 12 seconds, and the MSD for each EV is shown in FIG. 7 (at c, d, and e).

Particles of different sizes may exhibit distinct diffusion coefficients in the medium. The slopes (Δ) of the regression lines from the MSD calculations were determined to be 9.0 μm²/s, 12.9 μm²/s, and 21.3 μm²/s, corresponding to diffusion coefficients of 2.25 μm²/s, 3.225 μm²/s, and 5.32 μm²/s, respectively. Based on these diffusion coefficients, the estimated radii of the trapped EVs were approximately 91 nm, 63.5 nm, and 38.4 nm, as shown in FIG. 7 (at c, d, and e). These values fall within the expected size range for small EVs.

A contrast analysis for the three EVs was performed to assess their interferometric contrast. FIG. 7 (at b) presents the brightness intensity profile along the center of the Airy disk, marked by a black dotted line in the insets of FIG. 7 (at c, d, and e). The contrast was quantified by calculating the standard deviation of the intensity plot across the pixels, as shown in FIG. 7 (at f) (see Methods section for details).

The combination of mean square displacement (MSD) calculations and contrast analysis during both trapping and diffusion phases may support size estimation within the IET platform. The estimated particle sizes from Brownian motion analysis were correlated with the cube root of their interferometric contrast, as shown in FIG. 7 (at f). The results suggest that the cube root of the standard deviation of interferometric contrast exhibits a quasi-linear relationship with EV size.

To evaluate the capability of the IET platform for profiling the global chemical composition of trapped EVs, Raman signals were acquired from individual EVs at their respective trapping sites. Two representative Raman spectra are presented in FIG. 7 (at g and h). Differences in the Raman spectra may reflect the molecular heterogeneity of EVs. The Raman spectrum of the trapped EV1, shown in FIG. 7 (at g), exhibits distinct peaks in the range of 671 cm⁻¹ to 756 cm⁻¹, which may correspond to nucleic acids (NA) and phospholipids (Ph), as well as peaks between 1380 cm⁻¹ and 1470 cm⁻¹, which may be associated with NA, lipids, and proteins. The Raman spectrum of the trapped EV2, shown in FIG. 7 (at h), exhibits peaks in the ranges of 1133 cm⁻¹ to 1218 cm⁻¹ and 1499 cm⁻¹ to 1571 cm⁻¹, which may correspond to proteins and carotenoids (CN). The differences in molecular composition between the trapped EVs, as indicated in FIG. 7 (at g and h), suggest that Raman spectroscopy may provide insights into the global biomolecular composition of EVs within the IET platform.

Extracellular vesicles (EVs) may generally exhibit a spherical shape due to their lipid bilayer configuration. However, when two EVs adhere to each other or when an EV associates with other particles in solution, the overall shape may deviate from a sphere. The IET platform may detect such deviations by analyzing the interferometric contrast images of trapped EVs. Specifically, asymmetric particles may exhibit rotational motion while trapped, which may be visualized in their interferometric contrast images, as computationally studied in FIG. 4 (at c and d).

Additionally, label-free detection of supermeres using a trapping experiment was examined. Supermere samples were isolated and purified before being introduced into the IET platform. An interferometric contrast image of a trapped supermere was acquired, and its size was estimated using the calibration plot of the cube root of contrast as a function of particle size. Based on this analysis, the size of the trapped supermere was estimated to be approximately 58 nm, as indicated by the lower-left dot in FIG. 7 (at f).

The interferometric electrohydrodynamic tweezers (IET) platform described in this specification may provide advancements in nanoscale manipulation and characterization, supporting comprehensive analysis of nanoscale objects, including emerging extracellular nanoparticles such as supermeres and exomeres. By combining high-throughput rapid trapping with label-free imaging, this technology may facilitate the study of nanometer-scale objects, with potential applications in nanomedicine, environmental monitoring, and related fields. The capability of the IET platform to rapidly trap nanoscale particles, such as EVs and newly identified extracellular nanoparticles, in parallel within seconds and image them in a label-free manner may support investigations into nanoparticle and EV heterogeneity. This integrated approach to nanomanipulation and label-free characterization may expand the functionality of spectroscopic nanotweezers.

The IET platform may also support various applications, including (1) assessing the purity of EVs and lipoproteins, (2) investigating EV heterogeneity, (3) characterizing engineered EVs loaded with drug molecules, and (4) analyzing nanoplastics. By facilitating comprehensive single-particle analysis without the need for labeling or surface adhesion, the IET platform described in this specification may support new discoveries and applications in nanoscale science and technology.

In some examples, the IET platform may also be applied to the analysis of micro and nanoplastics in different sources, such as water and biofluids. The nanotweezer chip may be utilized to trap micro and nanoplastic particles in parallel, and to identify their size, refractive index, and chemical composition. Micro and nanoplastic particles, which may originate from the degradation of larger plastic materials in aquatic and terrestrial environments, may be introduced into the microfluidic channel 210 and rapidly trapped at the trapping sites using electrohydrodynamic flows generated by the voltage source 104.

In various implementations, the chemical composition of the trapped micro and nanoplastic particles may be determined from their Raman chemical fingerprint using the coherent light source 108 and the sensor 112, which may identify the polymer type (such as, for example, polystyrene, polyethylene, polypropylene, polyethylene terephthalate, or other polymeric materials) based on characteristic Raman spectral signatures. Once the chemical composition of a trapped micro or nanoplastic particle has been established via Raman spectroscopy, the refractive index may then be assigned to the particle, given that the refractive index is known for a given plastic polymer type. The assigned refractive index may then be used to accurately determine the size of trapped micro and nanoplastic particles from their interferometric contrast images captured by the coherent light source 106 and the sensor 110. In this manner, the Raman-derived chemical identification may inform the refractive index assignment, which in turn may improve the accuracy of size determination from interferometric contrast data.

Additionally, the shape of individual micro and nanoplastic particles may be assessed using interferometric contrast imaging via the coherent light source 106 and the sensor 110. By providing simultaneous determination of size, shape, refractive index, and chemical composition of individual micro and nanoplastic particles in a label-free manner, the system 100 may support environmental monitoring, assessment of plastic contamination in water, food sources, and biological fluids, and investigation of the distribution and heterogeneity of micro and nanoplastic pollutants.

### Methods

### 1. In-Plane and Out-of-Plane Scattering Simulation

The scattering patterns from a particle, interfered with by reflections from a thin gold film, may be analyzed using commercially available finite-difference time-domain (FDTD) simulation software (Lumerical). A spherical or elliptical particle may be positioned approximately 100 nm above a 15 nm-thick gold film, with an in-plane electric field monitor placed 25 nm above the top surface of the particle. The boundary conditions along the X, Y, and Z axes may be set to a perfectly matched layer (PML), and plane wave excitation with x-polarized light may be applied to analyze scattering patterns in both the in-plane and out-of-plane directions. First, the background field in the absence of the particle may be evaluated, followed by the analysis of the electric field distribution in the presence of the particle. The field distribution may then be squared to obtain the spatial intensity distribution, and each intensity distribution may be normalized according to the experimental conditions

$$( \frac{{I}_{det}}{{I}_{t r a n}} ) .$$

### 2. Forward and Backward Scattering Cross-Section Simulation

The contrast between forward and backward scattering from the particle may be calculated using FDTD (Lumerical) analysis. A total-field scattered-field (TFSF) source may be used for 520 nm excitation, with a scattering monitor positioned outside the TFSF source to collect only scattered light from the particle. The particle may be positioned approximately 500 nm above a 15 nm-thick gold film, with the top scattering monitor located 500 nm above the particle within a collection area of 2750 nm×2750 nm, mimicking a 70-degree half-angle and a total 140-degree collection angle. Perfectly matched layers may be used for the 3D boundary conditions, enclosing the entire FDTD calculation domain. The scattering efficiency, scaled by the scattering cross-section, may then be calculated by varying the particle size from 50 nm to 400 nm. The contrast

$$C = {( \frac{1}{t} )}^{2} {σ}_{scat} + 2 ( \frac{1}{2} ) \sqrt{{σ}_{scat}}$$

may be defined as C=β²σ_{scat}+2β\sqrt{σ_{scat}}, where β is an experimental constant or setup parameter, which may depend on the transmission of the gold film and indium tin oxide (ITO)-coated glass within the microfluidic channel.

### 3. Fabrication

The fabrication process may begin with a SiO₂ substrate. A 10-second descum process may be performed, followed by spin-coating an NR9 photoresist onto the substrate. The coated substrate may then be prebaked at 150 °C for 60 seconds. Next, the substrate may be exposed to 408 nm UV light for 7 seconds through a Cr mask, followed by a post-bake at 100 °C for 180 seconds. The exposed areas of the NR9 photoresist may be developed using MF-319 for 6 seconds, followed by a 10-second descum process, leaving NR9 pillars on the substrate. Subsequently, a 5 nm Cr adhesion layer may be deposited, followed by gold deposition via electron beam evaporation. The final step may involve sonication in acetone for 8 minutes to remove the remaining photoresist, yielding the finished chip.

In other examples, an alternative fabrication approach may involve using a positive photoresist, such as S-1805, with a suitable photomask. In such a configuration, the positive photoresist may be spin-coated onto the substrate, exposed through the photomask, and developed to define the pattern for the micron-scale holes 206 and the surrounding electrode structure. In still other examples, direct laser writing may be used to fabricate the nanotweezer chip. Direct laser writing may allow for maskless patterning of the electrode structures and the micron-scale holes 206, which may provide flexibility in adjusting the geometry and dimensions of the trapping sites without requiring the fabrication of a new photomask.

### 4. Mean-Squared Displacement (MSD) Calculation

Tracking the diffusion of particles in two dimensions and calculating the mean-squared displacement (MSD) of their trajectories may allow for the determination of diffusion coefficients for each single particle. The MSD may be calculated using the equation: MSD(τ)= [symbol] Δr(τ)² [symbol] = [symbol] [r(t+τ)−r(t)]² [symbol] , where τ is the lag time, t is the designated time, and r(t+τ) is the position of the particle at t+τ time frames. By tracking the diffusion of particles over time, diffusion coefficients may be extracted.

### 5. Quantification of Contrast

To quantify the contrast for scattering from the particles, the standard deviation (σ_{airy disk}) across the center of the particle may be determined, followed by calculating the standard deviation in the absence of a particle (σ_{background}). The difference between these values, raised to the power of one-third, may be defined as the effective standard deviation from the particle: σ_{eff}^{1/3}=(σ_{airy disk}−σ_{background})^{1/3}.

### 6. Particle Tracking Method

Particle tracking analysis may be performed using an open-source Python package, Trackpy (soft-matter/trackpy: Trackpy v0.5.0). The recorded video may be converted into an image sequence, after which the built-in tracking algorithm may be used to identify the location of the fluorescence of trapped particles in each image.

### Additional Example Implementations

The following describes additional example implementations of the system 100, including the nanotweezer device 102, the voltage source 104, the coherent light source 106, the sensor 110, the nanotweezer platform 114, and the analysis application 124.

Milk-derived extracellular vesicles (mEVs) may serve as drug carriers due to their resilience to enzymatic degradation in the digestive tract, their potential to be engineered to reduce immune rejection, and their capacity to deliver therapeutic cargo to target tissues. Precise, single-particle measurements of size, composition, and purity may support the development of mEV-based therapeutics.

In some examples, the system 100 may rapidly trap thousands of mEVs in parallel using the nanotweezer device 102, image the trapped mEVs via label-free interferometric scattering using the coherent light source 106 and the sensor 110, and perform automated analysis via the analysis application 124. The top electrode 202 of the nanotweezer device 102 may include a thin gold film patterned with an array of micron-scale holes 206 having a diameter of approximately 15 μm, which may generate radially converging AC-driven fluid flows to localize mEVs at trapping sites within seconds.

By temporarily deactivating the voltage source 104 to release the trapped mEVs, the analysis application 124 may track their Brownian motion to determine particle size from diffusion behavior. The analysis application 124 may further estimate refractive index from interferometric contrast signals captured by the sensor 110, supporting assessment of sample purity and heterogeneity. The voltage source 104 may further sort the trapped mEVs by size by varying the frequency of the applied AC signal. Together, these capabilities of the system 100 may support scalable trapping, real-time label-free imaging, size-based sorting, and AI-assisted analysis of mEVs.

Stable trapping of nanoscale particles in solution against randomizing Brownian motion may support progress in disciplines such as biology, colloidal chemistry, and biophysics. Various techniques for trapping nanoscale objects in solution have been developed, including plasmonic nanotweezers that concentrate light beyond the diffraction limit to create strong optical forces, photonic crystal cavity-based nanotweezers, resonant dielectric traps, and optothermal tweezers. Optical nanotweezers have evolved to offer improvements in trapping speed, throughput, and applicability to biologically relevant particles. Geometry-induced electrohydrodynamic trapping may facilitate rapid parallel trapping and deterministic placement of single nanoscale extracellular vesicles (EVs) at nanogap hotspots of plasmonic antennas. Artificial intelligence (AI) and machine learning approaches may be integrated with nanotweezer platforms to enhance trapping performance and improve trapping stability at low illumination powers.

Optical nanotweezer platforms may address fundamental biological questions and drive translational applications. Extracellular vesicles (EVs) are nanoscale biomaterials that mediate intercellular communication and may be inherently biocompatible. EVs may be engineered to deliver therapeutic cargo with high specificity to target cells or tissues. Identifying scalable sources of EVs, characterizing their heterogeneity, and accurately determining their size may support clinical applications, as particle size may directly influence drug-loading capacity and dosing requirements.

Single-particle level analysis to resolve size, surface markers, and cargo composition may support therapeutic use of EVs. Nanotweezer platforms for characterizing EV heterogeneity may benefit from integration with artificial intelligence to enhance trapping efficiency and analytical performance, supporting more precise characterization of EVs and accelerating their translation into clinical applications.

In some examples, the system 100 may trap EVs in parallel within seconds using the nanotweezer device 102 and integrate AI-assisted analysis via the analysis application 124 to track and characterize the motion, size, and refractive index of individual EVs in a label-free manner. The voltage source 104 may vary the frequency of the alternating current to sort EVs by size, providing the capability to selectively separate EVs from sub-10 nm contaminant particles such as small proteins and extracellular RNA not associated with EVs. In various implementations, the system 100 may be applied to milk-derived EVs (mEVs), which represent a scalable source of EVs. A single dairy cow may produce approximately 10,800 kg of milk annually, yielding over 1021 vesicles, and the resilience of mEVs to enzymatic degradation and their ability to traverse gastrointestinal barriers may make them suitable for EV-based therapeutics.

To achieve parallel trapping, the voltage source 104 may induce alternating current (AC) electro-osmotic flows within the microfluidic channel 210 to direct and localize EVs at predefined trapping sites defined by the micron-scale holes 206 in the top electrode 202. The trapped particles may then be imaged using the coherent light source 106 and the sensor 110 via interferometric scattering microscopy, which leverages the interference between incident and scattered light to detect nanoscale particles without fluorescent labeling while the particles are held in the traps.

To automate particle detection and tracking, the analysis application 124 may implement a deep learning-based image segmentation approach. In some examples, the analysis application 124 may employ a U-Net architecture, which is a convolutional neural network with an encoder-decoder structure and skip connections inspired by advances in medical imaging, to identify individual nanoscale particles in microscopy images captured by the sensor 110, even with limited training data. The analysis application 124 may extract particle centroids from the segmentation masks and track them across consecutive image frames to construct trajectories, from which diffusion coefficients may be extracted. This AI-assisted pipeline may enhance the efficiency, speed, and scalability of particle tracking under the complex imaging conditions encountered in the nanotweezer device 102.

The integrated capabilities of the system 100, combining the nanotweezer device 102, interferometric imaging via the coherent light source 106 and the sensor 110, and AI-based analysis via the analysis application 124, may support high-throughput trapping and label-free EV characterization, with potential to advance both fundamental EV research and therapeutic development applications.

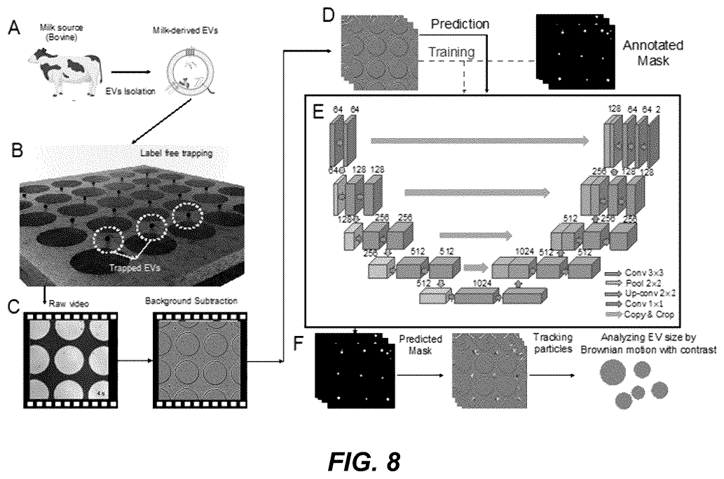

FIG. 8 illustrates conceptual schematics for electrohydrodynamic trapping, interferometric imaging, and machine learning architecture for analysis of milk-derived extracellular vesicles using the system 100, according to some examples. FIG. 8 (at a) depicts a schematic of EVs derived from bovine milk. FIG. 8 (at b) illustrates label-free trapping of milk-derived EVs onto the nanotweezer device 102, where trapped EVs are indicated by yellow dashed circles showing localization on patterned trapping sites defined by the micron-scale holes 206.

FIG. 8 (at c) presents representative frames from raw video microscopy of the EV trapping process captured by the sensor 110 (left), followed by background subtraction to enhance EV visibility (right). FIG. 8 (at d) illustrates background-subtracted images input into a deep learning framework implemented by the analysis application 124 for segmentation, where annotated masks are used during training to supervise the model to distinguish EVs from the background.

FIG. 8 (at e) depicts a schematic of the U-Net architecture used for EV segmentation by the analysis application 124. The network comprises encoding (left) and decoding (right) paths, including convolutional layers (Conv 3×3), pooling (Pool 2×2), up-convolution (Up-conv 2×2), and skip connections for spatial context preservation. FIG. 8 (at f) illustrates the trained model predicting masks highlighting EV locations, where these masks are used for particle tracking (middle) and analysis of EV size information (right).

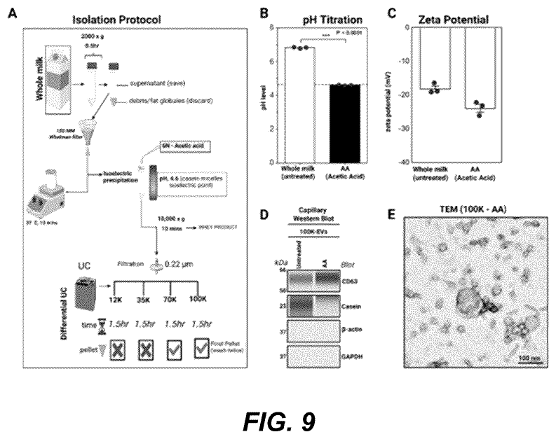

FIG. 9 illustrates schematics, charts, and images describing the isolation and purification of milk-derived extracellular vesicles and validation of sample purity, according to some examples. FIG. 9 (at a) depicts a workflow for isolation and purification of milk-derived extracellular vesicles by differential ultracentrifugation and isoelectric precipitation. In this workflow, milk acquired from a local grocery store was first separated by low-speed centrifugation to remove fat globules and passed through a 150 mm Whatman filter for pre-filtration. The pre-filtered supernatant was then treated with 6N (normality) acetic acid in a drop-wise manner to reduce the pH to approximately 4.6 for casein precipitation. Purified milk-derived EVs (mEVs) were isolated using high-speed differential ultracentrifugation.

FIG. 9 (at b) presents a quantification of pH measurements in untreated whole milk versus treated whole milk, with a bar graph showing a significant decrease in pH following acetic acid treatment, confirming acidification of the milk environment to the casein precipitation point (mean±SEM, *** P<0.0001). FIG. 9 (at c) presents zeta potential measurements of EV samples showing a consistent negative surface charge in both untreated and acetic acid (AA)-treated groups, with slightly increased magnitude after acidification (n=3 per group), suggesting surface charge preservation.

FIG. 9 (at d) presents capillary western blot analysis of EV-enriched 100K pellets. EV marker CD63 is present in both untreated and AA-treated groups. Casein and cytosolic contaminants (β-actin and GAPDH) are substantially reduced in the AA-treated group, indicating improved purity. FIG. 9 (at e) presents transmission electron microscopy (TEM) of AA-treated EVs (100K pellet), revealing intact, cup-shaped vesicles with heterogeneous morphology consistent with the expected size and appearance of milk-derived EVs, with a scale bar of 100 nm.

In some examples, a protocol for isolating EVs from bovine milk may be developed for use with the system 100. The abundance of casein micelles in the whey fractions may complicate the isolation of high-fidelity extracellular vesicles from milk. A purification protocol as illustrated in FIG. 9 (at a) may combine mild acidification using acetic acid with sequential centrifugation to yield EV fractions free of protein contaminants, particularly caseins, while retaining surface markers such as CD63 and preserving native zeta potential.

Treating whole ultra-pasteurized milk with acetic acid (AA) may reduce the pH from approximately 6.5 to approximately 4.6 (FIG. 9 (at b), P<0.0001) and may induce casein isoelectric precipitation while clearing the whey. This approach may minimize protein contamination prior to ultracentrifugation. Capillary western blotting of 100,000×g EV pellets (FIG. 9 (at d)) may reveal robust CD63 signal, indicating successful EV recovery. In AA-treated samples, casein bands may diminish markedly compared to untreated controls, and cytosolic markers such as β-actin and GAPDH may be virtually undetectable. These results indicate that AA-based isolation may efficiently eliminate major milk protein contaminants without compromising EV integrity.

The acid treatment may also enhance EV purity, though caution may be warranted with respect to potential effects on surface proteins. Capillary western analysis may show that CD63 remains intact following AA treatment, supporting the mildness of the protocol and its suitability for downstream functional studies. Zeta potential analysis of AA-purified EVs (FIG. 9 (at c)) may reveal a slight but statistically significant shift toward a more negative charge (−18 mV in untreated versus −24 mV in AA-treated samples). The preservation of consistent surface charge profiles indicates that AA treatment may not substantially alter EV membrane properties.

Collectively, these results suggest that acetic acid-based pH shifting may provide a gentle pretreatment strategy for milk, improving EV purity without compromising structural integrity or surface marker expression. The characteristic cup-shaped morphology observed in TEM images of the purified EV samples (FIG. 9 (at e)) may further support this conclusion.

Subsequently, the purified milk EVs may be introduced into the microfluidic channel 210 of the nanotweezer device 102 containing the trapping sites, as illustrated in FIG. 8. The voltage source 104 may induce an electro-osmotic flow in the presence of an applied AC electric field to achieve EV trapping. The trapping sites may comprise the top electrode 202 formed from a gold film with arrays of the micron-scale holes 206. In this example, the diameter of the micron-scale holes 206 is approximately 18 μm with a lattice spacing of approximately 2 μm.

The voltage source 104 may apply an AC voltage normal to the structured gold film, resulting in an AC electric field having both normal and tangential components. The tangential component of the AC field may act on the electrical double layer charge induced at the interface between the gold film and the adjoining fluid medium, inducing AC electro-osmotic flows. The AC electro-osmotic flow may act radially inward to localize the EVs at the center of the gold film, as indicated in FIG. 8 (at b).

The coherent light source 106 and the sensor 110 may visualize the trapped mEVs in real time using interferometric scattering microscopy, and the recordings may capture mEV motion over several seconds. To improve the visibility of mEVs for computational analysis, the analysis application 124 may process raw video frames using background subtraction, yielding enhanced contrast images with clearer mEV images against the trapping structures, as shown in FIG. 8 (at c). The analysis application 124 may generate the background image by averaging the frames captured after the particle is released from the trapping site. The analysis application 124 may then divide each individual frame by this average image to obtain the background-corrected result.

The analysis application 124 may use these background-corrected images as input data for a supervised deep learning segmentation pipeline, where annotated binary masks may train a U-Net convolutional neural network to detect and segment individual EVs (FIG. 8 (at d and e)). The U-Net model may include a contracting path for feature extraction and an expansive path for spatial localization, incorporating convolutional layers, max-pooling, up-convolution, and skip connections to retain resolution and contextual information (FIG. 8 (at e)). In this structure, a series of convolutional layers and continuous down-sampling layers (Encoder) may extract high-frequency features with a large receptive field. Up-sampling of the extracted deep features may then produce a pixel-level semantic prediction (Decoder). The skip connections between the encoder and decoder at different levels may alleviate the loss of spatial information, thus supporting the recovery of high-resolution features.

Once trained, the analysis application 124 may use the model to predict segmentation masks from new image frames, identifying EVs within the trapping regions, as shown in FIG. 8 (at f) (left panel). The analysis application 124 may then use the resulting binary masks for single-particle tracking across consecutive frames, extracting spatiotemporal trajectories and quantifying mEV dynamics, such as diffusion and trapping efficiency, as shown in FIG. 8 (at f) (center and right panels).

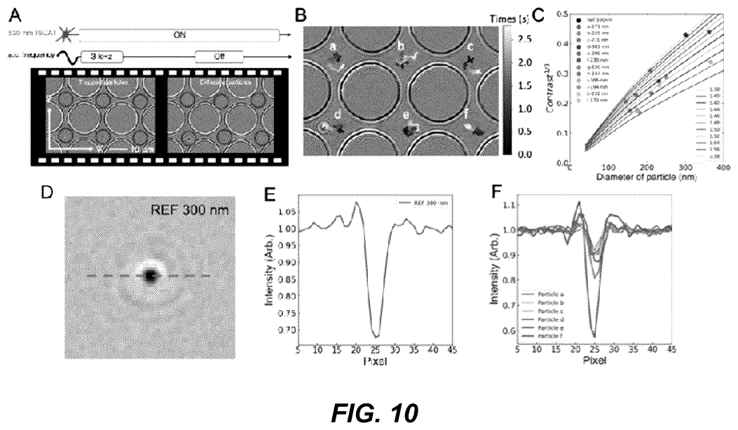

FIG. 10 illustrates images and charts showing label-free detection of single EVs and calibration of vesicle size using the system 100, according to some examples. FIG. 10 (at a) depicts clip images showing parallel trapping within seconds using the nanotweezer device 102, combined with label-free detection via the coherent light source 106 and the sensor 110. FIG. 10 (at b) presents representative trajectories of six particles over 2.5 seconds, as extracted by the analysis application 124, for use in calculating their Brownian dynamics.

FIG. 10 (at c) presents contrast versus particle size with varying refractive indices, using a 300 nm polystyrene (PS) reference particle and 12 milk-derived EVs, showing the relationship between particle contrast, size, and refractive index. FIG. 10 (at d) depicts a trapped 300 nm PS particle with a dotted line used to quantify the contrast. FIG. 10 (at e) presents an intensity plot across a pixel line of the 300 nm PS reference particle.

FIG. 10 (at f) presents representative intensity plots of six particles captured by the sensor 110 during the trapping period.

To correlate particle size and refractive index with the image contrast of a trapped particle, the analysis application 124 may monitor the Brownian dynamics after the voltage source 104 temporarily releases the particles by deactivating the applied AC voltage. The analysis application 124 may also quantify the image contrast while the particles are trapped, as shown in FIG. 10 (at a). For trapping and imaging, the coherent light source 106 may emit a 520 nm laser beam for label-free interferometric scattering imaging, while the voltage source 104 may apply a 3 kHz sinusoidal waveform to induce trapping. In response to the AC field being active, particles may be confined within the central regions of the gold film of the top electrode 202, while the particles may undergo Brownian diffusion in response to the voltage source 104 deactivating the AC voltage.

FIG. 10 (at b) depicts a representative recording of the experimental procedure, with six particles (a-f) clearly detected. The analysis application 124 may extract the trajectories of these particles over time using a U-Net model, showing random Brownian motion during the period the voltage source 104 deactivates the AC voltage, as described in FIG. 10 (at b). In this example, the contrast for a 300 nm polystyrene particle (such as, for example, Fluoro-Max R300, Thermo Fisher Scientific) may first be investigated as a reference particle with known refractive index to estimate the refractive index of other trapped milk-derived vesicles and particles.

To further quantify contrast, the analysis application 124 may extract and plot the radial intensity profiles of the 300 nm PS particle, as shown in FIG. 10 (at d and e). The dotted line crossing the particle indicates the position of the pixel used to measure its intensity, giving a value of approximately 0.43 contrast, which is plotted in FIG. 10 (at c).

Based on this reference, the scattering cross-section may be simulated using finite-difference time-domain (FDTD) analysis, taking into account a collection angle of approximately 129°, corresponding to a 1.2 numerical aperture. The scattering cross-sections for particles of different sizes, under the same experimental parameters, may then be applied to generate contrast (C=(β)²σ_{scat}+2(β)σ_{scat}) versus particle diameter while varying the refractive index, as shown by the different colored lines in FIG. 10 (at c). The analysis application 124 may then quantify the contrast of milk-derived particles in the interferometric scattering images during the trapping period (i.e., while the voltage source 104 maintains the AC voltage in an active state). To quantify contrast, the analysis application 124 may define a line crossing the center of each particle and calculate the standard deviation of the image intensity along that line, as described in FIG. 10 (at f).

Using the AI-assisted trajectory information, the analysis application 124 may calculate the mean squared displacement (MSD) as a function of lag time. The trajectories of six representative particles (a-f) are described in FIG. 10 (at b). The analysis application 124 may map the quantified size from Brownian dynamics and the contrast information of each particle in FIG. 10 (at c). The mapping of twelve investigated particles shown in FIG. 10 (at c) may provide the refractive index information for each particle, with the distribution of refractive index ranging from approximately 1.38 to approximately 1.50. This mapping may also indicate that particles with a refractive index higher than approximately 1.5 are likely milk-derived residue particles such as protein aggregates.

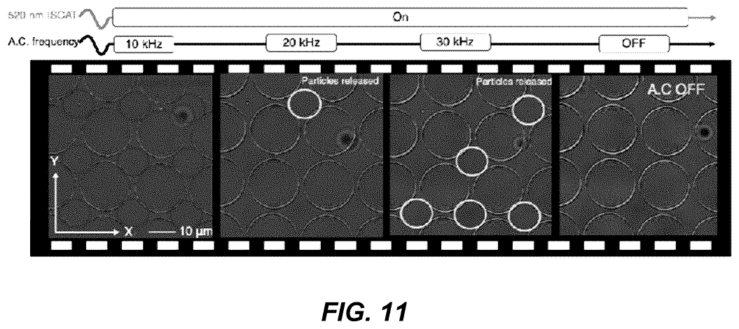

FIG. 11 illustrates frames showing a sorting experiment of multiple EVs using the system 100, in which the voltage source 104 varies the applied frequency from 10 kHz to 30 kHz, according to some examples.

In some examples, size-sorting experiments may be carried out by the voltage source 104 varying the applied AC field frequency between approximately 10 kHz and approximately 30 kHz. At approximately 10 kHz, the nanotweezer device 102 may stably confine milk-derived EVs within the trapping region. In response to the voltage source 104 increasing the frequency to approximately 20 kHz, smaller particles may begin to escape from the traps, as shown in FIG. 11. A further increase to approximately 30 kHz may cause additional particles that remained at 20 kHz to also be released. At this point, the population that remains localized may be predominantly composed of larger EVs.

This frequency-dependent sorting may arise because the particle-surface interaction force that stabilizes out-of-plane confinement may be strongest at lower frequencies and may progressively weaken as the frequency increases. At higher frequencies, the electrical double layer surrounding the particle may not be fully polarized in response to the rapidly oscillating field, thereby reducing the effective trapping force. As a result, smaller EVs, along with free proteins and extracellular RNA fragments that diffuse more readily, may be preferentially ejected as the voltage source 104 raises the AC frequency.

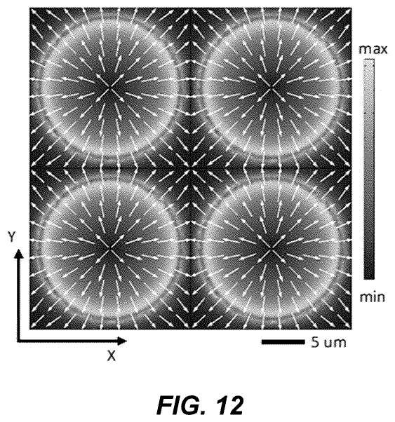

FIG. 12 is a diagram illustrating the in-plane AC electro-osmotic flow distribution within the nanotweezer device 102, showing the flow directed inward toward the gold film region of the top electrode 202, according to some examples.

In some examples, the velocity distribution of the induced AC electro-osmotic flow within the nanotweezer device 102 may be calculated using a Laminar Flow module. This may be accomplished by solving the Navier-Stokes equation, expressed as ρ₀[u(r)·∇]u(r)+∇ρ(r)−η∇²u(r)=F. In this equation, ρ₀ represents the density of the fluid, ρ(r) represents the spatial pressure, η represents the viscosity of the medium, u(r) represents the fluid velocity, and F represents the body force.

A slip velocity boundary condition defined by the Helmholtz-Smoluchowski slip velocity may be applied, with a magnitude given by

$${u}_{s} = - \frac{{ε}_{w} ζ}{η} {E}_{∥} .$$

In this equation, uₛ represents the velocity of the AC electro-osmotic flow, ε_{w} represents the permittivity of the fluid medium, ζ represents the zeta potential, η represents the fluid viscosity, and E_{∥} represents the tangential component of the electric field established near the surface. In this example, the zeta potential may be set as −15 mV and the relative permittivity of the fluid may be set as 78.

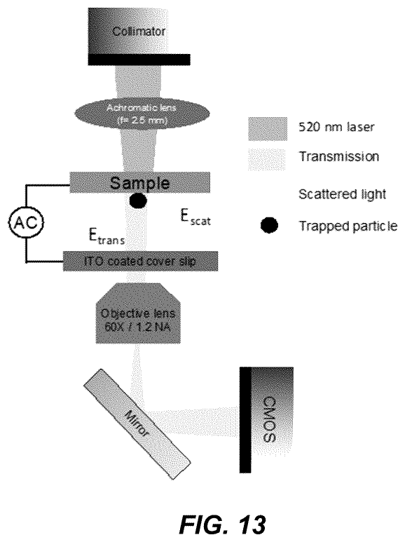

FIG. 13 is a schematic diagram illustrating AC electro-osmotic flow trapping and label-free detection within the nanotweezer device 102 using the coherent light source 106 and the sensor 110, according to some examples.

After the AC electro-osmotic flow transports the particles, the coherent light source 106 and the sensor 110 may directly image the particles without adhesion on the gold surface of the top electrode 202 or fluorescent labeling, using interferometric imaging. For this purpose, the coherent light source 106 may illuminate the sample with a 520 nm imaging laser, allowing part of the light to transmit through the gold film. The transmitted light may then be partially scattered by the trapped particles. The detected signal at the sensor 110, consisting of both transmitted and scattered light, may be expressed as follow: I_{det}=|Eₜᵣₐₙ+E_{scat}|²=|E_{inc}|²(t²+|s|²+2t|s|cosθ). In this equation, Eₜᵣₐₙ represents the transmitted electric field, E_{scat} represents the scattered electric field, t represents the transmission coefficient, s represents the scattering coefficient from the particle in the medium, and θ represents the phase difference between the scattered light and the light transmitted through the thin gold film.

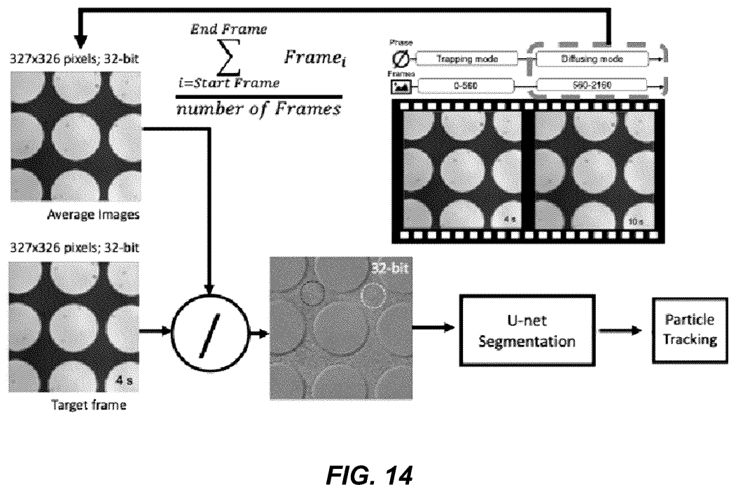

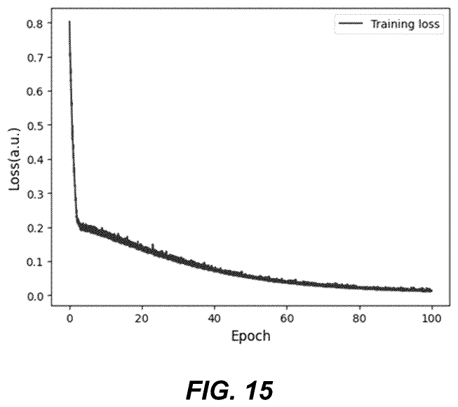

FIG. 14 is a schematic diagram illustrating a background subtraction procedure from a raw image to a contrast-enhanced image, as performed by the analysis application 124, according to some examples. FIG. 15 is a chart illustrating the evolution of the binary cross-entropy loss for the U-Net particle-segmentation model implemented by the analysis application 124 during 100 training epochs, according to some examples.

The intensity normalization between the detected and incident transmitted light, expressed as

$$\frac{{I}_{det}}{{I}_{t r a n}} ,$$

may yield the contrast after the imaging process. The image processing workflow implemented by the analysis application 124 may begin with averaging multiple frames and dividing the target frame by the averaged image to enhance particle contrast. The analysis application 124 may then process the resulting images using U-Net segmentation followed by particle tracking to analyze trapping and diffusion behavior.

In some examples, the analysis application 124 may train a U-Net convolutional neural network to segment trapped particles in videos. The training set may consist of 260 grayscale frames, each paired with a hand-annotated binary mask. Training may be carried out for 100 epochs on a single NVIDIA Tesla T4 GPU (16 GB memory) with a batch size of four, using an Adam optimizer and an initial learning rate of 1×10⁻⁶. As shown in FIG. 15, the binary cross-entropy loss may approach zero after approximately 80 epochs.

The analysis application 124 may apply the trained model to every video frame to generate particle masks. To construct particle trajectories, the analysis application 124 may extract centroid coordinates of each particle and link them across every frame. The analysis application 124 may then perform mean-squared displacement analysis to yield diffusion coefficients for the particles, and the diameters of the particles may be obtained from the Stokes-Einstein relation.

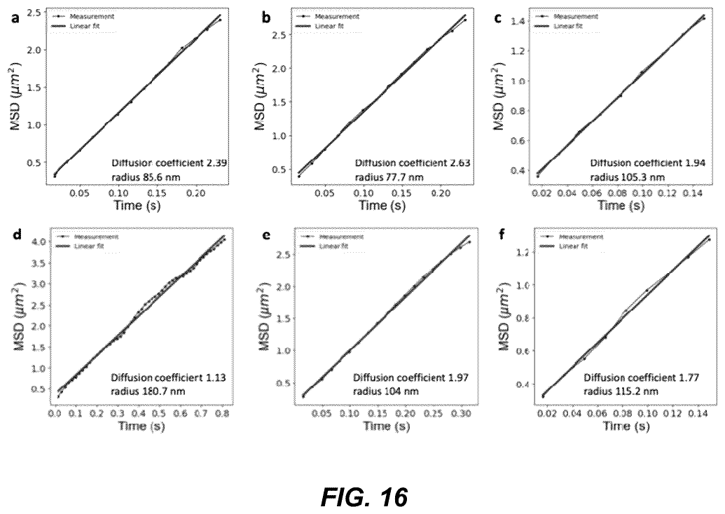

FIG. 16 illustrates charts showing the mean-squared displacement (MSD) of particles as a function of lag time t, as calculated by the analysis application 124, according to some examples. The red line represents least-squares fits to the experimental data (blue dotted line).

The analysis application 124 may evaluate the mean-squared displacement (MSD) of every tracked particle as a function of the time lag(τ). The analysis application 124 may fit each MSD versus t curve with a linear model, MSD=4Dτ, and may obtain the diffusion coefficient D from the slope. Representative MSD versus lag time plots for particles a, b, c, d, e, and f in FIG. 10 and their linear fits are shown in FIG. 16.

In some examples, the milk collection and sample processing described in the additional example implementations section may proceed as follows. A 2% grade A reduced-fat bovine milk may be commercially pooled from a local grocery store. To minimize substantial degradation and alteration of pH, the milk samples may be processed within four hours of procurement. Prior to isolation of extracellular vesicles, fresh milk samples may be centrifuged at 2,000×g for 30 minutes at 4 °C to remove cream and large particulates. The resulting supernatant of the defatted milk may be collected with a pipette into separate 50 ml conical tubes, avoiding contamination with sedimented pellets. A grade 1 150 mm Whatman filter (such as, for example, Cytiva, 18123982) may be used to pre-filter the milk supernatant to remove residual fat globules and casein clumps before differential ultracentrifugation.

In some examples, the isoelectric precipitation of casein described in the additional example implementations section may proceed as follows. To precipitate casein and enrich the milk whey fraction, the defatted milk may first be warmed to 37 °C for 10 minutes. 6N acetic acid (such as, for example, Sigma-Aldrich, 102762795) may then be added to the milk at a volume ratio of 1:100 (acetic acid to milk), followed by incubation for 5 minutes at room temperature. The pH of the milk sample may be validated to be at approximately 4.6 following acid treatment. The milk samples may then be centrifuged at 10,000×g for 10 minutes at 4 °C, after which the supernatant (designated whey) may be collected and the casein pellet discarded. The whey samples may then be filtered through a 0.22 μm membrane filter (such as, for example, Millipore, 0000430715) to eliminate residual debris.

In some examples, the differential ultracentrifugation and EV purification described in the additional example implementations section may proceed as follows. The designated whey may be subjected to successive differential ultracentrifugation for EV isolation. Samples may be ultracentrifuged at 12,000×g (12K), 35,000×g (35K), 70,000×g (70K), and 100,000×g (100K) for 90 minutes each at 4 °C using a Ti45 rotor (such as, for example, Beckman Coulter, Optima XPN-80 Ultracentrifuge). The pellets from the 12K and 35K steps may be discarded, while the pellets from the 70K and 100K steps may be retained for further analysis.

The EV-containing pellet from the 100K step may be resuspended in phosphate-buffered saline (PBS, pH 7.4), and a washing step may be performed by a second ultracentrifugation at 100,000×g for 60 minutes at 4 °C using a TLA-110 rotor (such as, for example, Beckman Coulter, Optima MAX-XP Ultracentrifuge). The final EV pellet may be resuspended in 500 μL PBS after discarding the supernatant. To remove residual protein aggregates or precipitates, the EV suspension may be clarified by a final centrifugation at 10,000×g for 5 minutes at 4 °C, and the supernatant may be collected as purified milk-derived EVs (mEVs). The isolated mEVs may be stored at 4 °C for immediate downstream analysis or kept at −20 °C in multiple 1.5 mL microcentrifuge tubes (such as, for example, VWR, 87003-294) for short-term storage. For interferometric scattering imaging using the coherent light source 106 and the sensor 110, the mEVs may be further suspended in filtered deionized water at a 1:2000 dilution following particle characterization by nanoparticle tracking analysis (NTA).

In some examples, the particle size distribution and concentration of isolated mEVs described in the additional example implementations section may be characterized using a NanoSight NS300 system (Malvern Instruments, Malvern) equipped with a 405 nm laser module and a temperature-controlled sample chamber. Prior to analysis, EV samples may be diluted in filtered 1× PBS to a final concentration of 1:2000 and gently suspended by repeated aspiration through a micropipette to minimize vesicle clustering. Approximately 1 mL of diluted sample may be introduced into the NTA chamber using a syringe-driven pump, and videos may be captured at a frame rate of 30 frames per second. Instrument parameters may be set as follows: camera level 7, detection threshold 10, and flow rate 50, with all measurements conducted at 25 °C. Data may be processed and analyzed using NanoSight NTA software version 3.2.

In some examples, the zeta potential measurements of mEVs described in the additional example implementations section may be performed using a Zeta View® PMX 120 instrument (Particle Metrix) equipped with a laser-based tracking system. EV samples may be diluted in filtered 1× PBS to an appropriate concentration (typically yielding 100-300 particles per frame) at a temperature of 25 °C. Samples may be homogenized by gentle pipetting before measurement to minimize vesicle aggregation. Measurements may be acquired in triplicate across 10 standard positions within the cell chamber. Instrument settings may be configured as follows: sensitivity set to 85, shutter speed of 70, and a frame rate of 30 frames per second. Data acquisition and analysis may be performed using Zeta View software (version 4.4), and results may be expressed as mean±standard deviation from triplicate measurements.

In some examples, the capillary western immunoblotting described in the additional example implementations section may be performed using an automated ProteinSimple Wes System. EV protein lysates or whole-tissue extracts may first be diluted with 0.1× Sample Buffer. Four parts of the diluted sample may then be mixed with one part of 5× Fluorescent Master Mix, which contains 5× sample buffer, 5× fluorescent standards, and 200 mM dithiothreitol (DTT). The mixture may be denatured at 95 °C for 5 minutes prior to loading. The fluorescent standard, comprising three internal fluorescent proteins, may serve as a migration reference to normalize protein separation distances across individual capillaries, as the molecular weight ladder may be applied only to the first capillary.

After denaturation, prepared samples, blocking reagent, diluted primary antibodies (1:1000 for anti-CD63 [such as, for example, BIO-RAD, MCA2042GA], 1:1000 for Casein [such as, for example, Thermo Fisher Scientific, BS-0813R], and 1:2000 for both GAPDH [such as, for example, CST, D16H11] and β-actin [such as, for example, CST, #4970]), HRP-conjugated secondary antibodies, and chemiluminescent substrate may be loaded into designated wells of the assay plate along with a biotinylated molecular weight ladder. Protein separation and immunodetection may be performed automatically within the Jess capillary system, which integrates electrophoresis, antibody incubation, and detection into a single streamlined workflow. Data may be analyzed using Compass software (such as, for example, ProteinSimple, version 6.3.0).

In some examples, the transmission electron microscopy described in the additional example implementations section may be performed as follows. Ultrathin Carbon Type-A 400-mesh copper grids (such as, for example, Ted Pella, 01822) may be pre-treated with plasma for 10 seconds using a glow discharger (such as, for example, PELCO). A volume of less than 20 μL of EV suspension (1:5000) may be deposited onto a paraffin film, and the grid may be placed into the EV solution and incubated for 1 minute at room temperature to allow adsorption. The grid may be briefly washed in filtered deionized water while excess solution is removed on wick paper. For conventional negative staining, the grid may be incubated in a solution of less than 20 μL of 2% uranyl acetate (such as, for example, Ted Pella, 19481) for 1 minute. The grid may then be allowed to dry at room temperature without additional washing. Samples may be imaged using a Tecnai TG2 Osiris S/TEM system (such as, for example, FEI, USA) at 200 kV, and images may be acquired using a 4K CETA TEM CCD camera (such as, for example, Olympus).

In some examples, the fabrication of the nanotweezer device 102 described in the additional example implementations section may proceed as follows. The fabrication process may begin with a SiO₂ substrate. In some examples, the substrate includes additional or alternative materials. For applications in which acquisition of a Raman signal is vital and increased laser power is employed, the substrate may be changed to a material having a higher thermal conductivity compared to SiO₂ to dissipate excess heat for proper thermal management. Suitable alternative substrate materials may include sapphire, aluminum nitride (AlN), silicon carbide (SiC), or diamond. These materials may offer significantly higher thermal conductivity relative to SiO₂, which may reduce localized heating at the trapping sites and support the use of higher excitation laser powers without thermal damage to the sample or the nanotweezer chip.

An initial 10-second descum step may be carried out, after which NR9 photoresist may be spin-coated onto the surface. The coated substrate may then be baked at 150 °C for 60 seconds to solidify the resist. UV exposure at 408 nm may be performed for 7 seconds using a chromium mask, followed by a post-exposure bake at 100 °C for 180 seconds. Development in MF-319 for 6 seconds may reveal the pattern, and a subsequent 10-second descum step may result in NR9 pillar structures on the substrate. A thin 10 nm chromium adhesion layer may be deposited first, followed by gold deposition through electron beam evaporation. The sample may then be sonicated in acetone for 8 minutes to lift off the remaining resist, yielding the completed chip.

In some examples, the quantification of contrast described in the additional example implementations section may proceed as follows. To evaluate the scattering contrast from the particles, the analysis application 124 may measure the variation in intensity at the particle's center, quantified as the standard deviation (Fairy disk). The analysis application 124 may separately determine the background variation without any particles present (@background). The analysis application 124 may then calculate the effective particle-induced contrast by taking the cube root of the difference between these two standard deviations, expressed mathematically as (σ_{airy disk}−σ_{background})^{1/3}.

In some examples, the particle tracking described in the additional example implementations section may be conducted using the open-source Python package Trackpy (such as, for example, soft-matter/trackpy: Trackpy v0.5.0), which employs a built-in algorithm to detect the positions of trapped particles in each frame.

In some examples, the U-Net-based particle tracking described in the additional example implementations section may be implemented by the analysis application 124 as follows. The U-Net architecture is illustrated in FIG. 8 (at e). The encoder part (left side) may contract the image to a latent space, and the decoder part (right side) may reconstruct the image from the latent space. The encoder part may consist of a series of repeated 3×3 convolutions, each followed by a rectified linear unit (ReLU) and a 2×2 max pooling operation for downsampling. At each downsampling step, the number of feature channels may be doubled.

The decoder part may consist of a series of 2×2 upsampling convolutions that halve the feature channels, and two additional 3×3 convolutions, each followed by ReLU. The concatenation of the correspondingly cropped feature map between the encoder and decoder at different levels may compensate for the loss of border pixels at every convolution. In total, the architecture may include 23 convolutional networks.

The network may be implemented in PyTorch and trained on a Google T100 GPU using microscopy particle trapping images and corresponding mask images. The mask images may be annotated manually using CVAT. The analysis application 124 may employ Dice loss (D_{score}) as the loss function to evaluate the performance of prediction: D_{score}=2(|P|∩|T|)/(|P|∪|T|). In this equation, |P| represents the predicted images and |T| represents the ground truth mask images. The analysis application 124 may use the trained neural network to predict the location of particles in all frames in a video. The analysis application 124 may then use the Trackpy package in Python to construct the trajectories of each particle and analyze particle sizes to calibrate the contrast information of each particle. This pipeline is illustrated in FIG. 8.

Thus, the system 100, including the nanotweezer device 102, the voltage source 104, the coherent light source 106, the sensor 110, and the analysis application 124, may provide an integrated platform that combines electrohydrodynamic trapping, interferometric scattering microscopy, and AI-assisted tracking for rapid, label-free analysis of milk-derived extracellular vesicles (mEVs). The system 100 may support parallel trapping of EVs within seconds, high-sensitivity imaging, and automated single-particle sizing, yielding distributions consistent with the inherent heterogeneity of milk EVs. This non-perturbative workflow may preserve vesicle structure and dynamics while also supporting simultaneous assessment of additional properties such as refractive index, paving the way for assessment of the purity of EV preparations. Together, these capabilities of the system 100 may establish a scalable and versatile approach for advancing both fundamental studies and translational applications of EVs.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium-such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A system comprising:
a nanotweezer including a first electrode and a second electrode, the nanotweezer configured to generate electrohydrodynamic flows between the first electrode and the second electrode to trap nanoscale particles;
a first coherent light source configured to illuminate the trapped nanoscale particles;
a second coherent light source configured to illuminate the trapped nanoscale particles;
a first sensor configured to monitor a first interaction between the first coherent light source and the trapped nanoscale particles;
a second sensor configured to monitor a second interaction between the second coherent light source and the trapped nanoscale particles; and
an electronic processor configured to:
determine particle sizes of the trapped nanoscale particles based on sensor signals from the first sensor, and
determine compositions of the trapped nanoscale particles based on sensor signals from the second sensor.

2. The system of claim 1, wherein the first sensor is an imaging sensor configured to capture interferometric contrast images of the trapped nanoscale particles.

3. The system of claim 1, wherein the first sensor is a complementary metal-oxide-semiconductor sensor.

4. The system of claim 1, wherein the electronic processor is configured to determine particle shapes of the trapped nanoscale particles based on sensor signals from the first sensor.

5. The system of claim 1 wherein the electronic processor is configured to determine particle sizes of the trapped nanoscale particles based on elastic scattering as indicated by sensor signals from the first sensor.

6. The system of claim 1 wherein the electronic processor is configured to determine particle sizes of the trapped nanoscale particles based on scattering contrast as indicated by sensor signals from the first sensor.

7. The system of claim 1 wherein the electronic processor is configured to determine particle shapes of the trapped nanoscale particles based on interferometric contrast as indicated by sensor signals from the first sensor.

8. The system of claim 1, wherein the electronic processor is configured to determine chemical compositions of the trapped nanoscale particles based on sensor signals from the second sensor.

9. The system of claim 1, wherein the electronic processor is configured to determine molecular compositions of the trapped nanoscale particles based on sensor signals from the second sensor.

10. The system of claim 1, wherein the electronic processor is configured to determine compositions of the trapped nanoscale particles based on inelastic scattering as indicated by sensor signals from the second sensor.

11. The system of claim 1, wherein the electronic processor is configured to determine compositions of the trapped nanoscale particles based on Raman scattering as indicated by sensor signals from the second sensor.

12. The system of claim 1, wherein the first electrode includes an array of micron-scale holes.

13. The system of claim 1, wherein the first electrode includes a gold material.

14. The system of claim 1, wherein the second electrode includes a transparent material.

15. The system of claim 1, wherein the second electrode includes an indium tin oxide material.

16. The system of claim 1, wherein the nanotweezer includes a microfluidic channel formed between the first electrode and the second electrode.

17. The system of claim 1, wherein the nanotweezer includes a voltage source electrically coupled to the first electrode and the second electrode.

18. The system of claim 1, wherein the voltage source is configured to vary a frequency of the alternating current to sort the trapped nanoscale particles by size, wherein increasing the frequency preferentially releases smaller nanoscale particles from trapping sites while retaining larger nanoscale particles.

19. The system of claim 1, wherein:
the voltage source is configured to temporarily deactivate the alternating current to release the trapped nanoscale particles; and
the electronic processor is configured to track motion of the released nanoscale particles via the first sensor, extract diffusion coefficients from the tracked motion, and determine particle sizes of the released nanoscale particles based on the extracted diffusion coefficients.

20. The system of claim 1, wherein the electronic processor is configured to:
execute a trained neural network comprising an encoder-decoder architecture with skip connections to generate segmentation masks identifying locations of individual trapped nanoscale particles in imagery captured by the first sensor;
extract particle centroids from the segmentation masks; and
construct particle trajectories across consecutive image frames.
